(19) United States
(12) Patent Application Publication
(10) Pub. No.: US 2022/0327529 A1
(43) Pub. Date: Oct. 13, 2022

(54) Advanced Transactional Protocols And Ecosystem For Smart Contract Authoring And Deployment

(71) Applicant: Richard K. Williams, Cupertino (CA)

(72) Inventors: RICHARD K. WILLIAMS, Cuperino, CA (US); IEVGEN VERZUN, Kiev (UA)

(21) Appl. No.: 17/711,015

(22) Filed: Mar. 31, 2022

Related U.S. Application Data
(60) Provisional application No. 63/168,597, filed on Mar. 31, 2021.
(60) Provisional application No. 63/281,317, filed on Nov. 19, 2021.

(51) Int. Cl. G06Q 20/38; G06Q 20/06; G06Q 20/22; H04L 9/32

(52) U.S. Cl. CPC G06Q 20/3825; G06Q 20/3827; G06Q 20/065; G06Q 20/223; H04L 9/3213; H04L 2209/56

(57) ABSTRACT

A fully autonomous smart contract authoring system capable of concurrently generating multiple smart contracts from a single source file for a variety of blockchain networks from a single source file is disclosed.

### CROSS-REFERENCE TO RELATED APPLICATIONS

This application is related to and claims the priority of U.S. Provisional Application No. 63/168,597, filed Mar. 31, 2021, titled “Advanced Transactional Protocol And Ecosystem For Smart Contract Authoring And Deployment” and U.S. Provisional Application No. 63/281,317, filed Nov. 19, 2021, titled “Autonomous Protocol And Platform For DeFi Token Launches And Collateralized Token Trading.” Each of the foregoing applications is incorporated herein by reference in its entirety.

### SCOPE OF INVENTION

This invention relates to blockchain decentralized applications, smart contract execution, and blockchain processing.

### BACKGROUND OF INVENTION

In the processing of data and programs stored, distributed, and executed on public blockchains, the blockchain and its network replaces the role of commercial banks as transactional fiduciaries. Blockchain features include
Permissionless transactional medium
Trustworthy asset (or contract) validation mechanism
Distributed ledger (DLT or blockchain) for record keeping
Virtual machine for executing smart contracts

As a transactional medium, blockchains enable two parties to engage in commerce without knowing or meeting one another, thereby protecting the privacy and true identity of both. A second key function of a blockchain network is its ability to validate a digital asset, virtual currency, or a smart contract to prevent counterfeiting, double spending and contract fraud.

The third function of a blockchain network is its ability to store data, i.e. to function as a database immune to single point failures or attacks. DLTs, an acronym for distributed ledger technology represent a entire class of linear database constructs. The terms DLT and blockchain are often used synonymously. While it is true that a blockchain is a DLT, the converse is not necessarily the case. A more accurate description is that a DLT is a special type of database, and a blockchain is one particular implementation of a DLT.

Specifically, distributed ledger technology (DLT) comprises a distributed database managed by multiple participants spread across multiple nodes. Ostensibly, storing data on different nodes confers an added degree of data security because an attack on any one node (or its local data storage devices) is unable to access the full dataset contained in the diffuse database. But storing data distributed across multiple devices in multiple locations does not ensure a DLT is decentralized.

A truly decentralized database requires both the data content and the database access to be distributed. A DLT database with centralized control access to a distributed database, e.g. a CFO's desktop computer, is not decentralized because focused attacks on the control interface can access the entire content of the DLT regardless of where the contents are held.

The blockchain, a fully decentralized version of a DLT overcomes this vulnerability by removing the central control node entirely. Every block contains content (the payload of the blocks) plus a block header. Contents of the block header vary by blockchain but generally include a block-number; a time-stamp to ensure blocks are entered sequentially; and the block's unique digital identity needed for cryptographic validation or mining.

The payload of a block may contain passive information such as financial transactions; an identifying “address” of a digital asset or virtual currency; a linear data base or file; a creative work; or other database records. The payload may also contain software in the form of a computer program or a decentralized application such as a smart contract (described in a subsequent section). The payload may contain both encrypted (ciphertext) and unencrypted (plaintext) data.

Aside from its payload, each block is time-stamped to provide an immutable chronological record of events. Another key element of every entry on a blockchain is a digital identity or signature, some means by which a third party can validate the block is valid and not fraudulent or corrupted.

Cryptography in DeFi: One way users control access to blockchain content and validate its authenticity is through the use of cryptography^{[35][36][37]}. In broad terms, cryptography employs one of two stratagems,
Encryption and decryption with cryptographic key exchange
Hashing (encryption only), no key exchange required

In the reversible process of encryption and decryption, a payload's content (e.g. transactions, data, files, images) is encrypted using a defined algorithm with a cryptographic key to produce an encrypted file called ciphertext. Using a decryption key (uniquely corresponding to the encryption key), another party can then recover original unencrypted (plaintext) content from the ciphertext.

In order to decrypt the file, however, the reader must first obtain a copy of the decryption key in a process called a key exchange. A key exchange safely performed over unsecured channels is referred to as a public key exchange. Although the mechanisms of public key infrastructure (PKI) for exchanging cryptographic keys are many, one common algorithm is a split key exchange.

During a split key exchange, the intended recipient of encrypted content (not the sender) creates two keys—a public encryption key and a private decryption key. The cryptographic process is asymmetric in that the decryption key can decrypt content encrypted with the encryption key, but the encryption key cannot be used for decryption.

The recipient then sends the encryption key to the sender node to encrypt their content accordingly and the resulting ciphertext is sent to the recipient. Since the encryption key is not useful for decrypting the ciphertext, both the public key and the encrypted file can be communicated publicly over open channels (hence it's the name “public key”).

In most cases, however, sharing a cryptographic key with a user requires prior approval to access the contents of a block. Such applications are referred to as permissioned systems because access must be granted by an administrator. Ironically, not only is PKI used by blockchains for trusted validations, but now blockchains are being symbiotically used to improve the integrity of PKIs.

While PKI methods can be used to protect content in a blockchain, it is unnecessarily complex for validators simply to verify the authenticity of the chain has not been corrupted or the provenance of its blocks altered. Instead an alternative approach called a permissionless system is preferred, one where miners don't need to request access to the blockchain and where sufficient information is publicly available to independently verify the veracity of the chain.

This is where the role of a cryptographic hash comes in. A hash is a cryptographic process whereby a file of any size is encoded into a fixed length ciphertext based on the content of the file being hashed, not on a separate cryptographic key. Properties of a cryptographic hash include:
Unidirectional—Content can be converted into a hash but the hash cannot be analyzed to reveal the content that created it (even when the hashing algorithm is known)
Highly non-linear—Small input perturbations cause dramatic changes in hash output affecting over half the bits (sometimes called an avalanche effect)
Random—The output of a hash cannot be predicted from its input file
Fixed length—The hash output is of fixed length regardless of the size of the input.
Deterministic—The same file input to a hash will always produce the same output
Collision resistant—It is extraordinarily unlikely statistically that two different source files could produce the same hash output. For all practical purposes, every hash output is unique.

Compared to encryption, an important distinction of hashing is that the process is unidirectional—once a file is hashed the original content cannot be recovered or extracted from the hash output. Although at first glance the process of making a file no one can read seem useless, as it turns out hashing has become a critical component in verifying all blockchain transactions today.

The unique property of the hashing process is its deterministic yet highly non-linear behavior. Even the most minute perturbation in the source file produces vastly different unrecognizable hash code outputs. Statistically, this property means the only way the hash of one file will match the hash of another file is if the two files are identical. Metaphorically, a hash is a digital fingerprint useful to reject imposters, exclude fraudulent blocks, and prevent content tampering. A hash's fingerprint feature can be used to confirm a sequence of blocks in a chain are self-consistent and belong together. The hash of a hash of a hash, is called a hash chain, for example:

H[H[H[H[x]]]]≡H⁴[x]

Hash chains render sequential verification of a chain simple—the insertion of a fake block will produce a cascade of inconsistency errors easily detected as fraudulent by any third party validator. Adapting hashing to the process of validating a blockchain for 3^{rd} party inspection, blockchains employ nested hash chains. In nested hash chains, each block includes both a hash H[x] of its predecessor blocks plus new content including transactions, data, images, etc. For example if x=n, n−1, n−2, n−3 . . . the nesting of a hash chain can be represented by the data structure:

block (n)=content (n)+H[block (n−1)]

block (n−1)=content (n−1)+H[block (n−2)]

block (n−2)=content (n−2)+H[block (n−3)] . . . .

As depicted in FIG. 1 a succession of data blocks 2a, 2b, 2c, 2d . . . are arranged linearly in time to form a digital ledger or chain, where new entries can only be appended onto the end of the chain. The chain of blocks, or blockchain 1, includes content related to transactions, financial information, artistic content represented by payload 8 (with entries A, B and C) and a block header 3 containing metadata 6 and sub-headers 5 and 7 used in validating existing and new blocks. Whenever a new transaction is started, a network of computer nodes referred to as miners or validators must first confirm if the blockchain they are looking at is valid or corrupted. Since the identical blockchain is perpetually persistent across tens of thousands of devices it is impossible for a hacker to find and corrupt enough blockchains to alter the outcome of a pending transaction. Without a central authority to audit the ledger (the way commercial banks validate their financial records) blockchain integrity is validated using cryptography including encryption and through the process of cryptographic hashing described previously. By successively stringing a series of hashes corresponding to the arrangement and contents of the blockchain's blocks any alternation, insertion, or deletion of a block can easily be detected without knowing what the block contains. A string of hashes containing prior hashes is referred to as a nested hash chain.

In a nested hash chain each block is hashed and embedded into the block header of the subsequent block on the chain. As shown the content of the entire block 2b (labelled as block (n−2)) is hashed by hash function 4b and the output embedded into sub-header 5 contained within block header 3 within block 2c. Similarly the content of pervious block 2a is hashed 4a and embedded into the block header of block 2b. In this manner no block is free of containing the hash of all the blocks before it in time. Metadata sub-block 6 may also contain a time and date stamp making the blockchain linearly temporal. During a block's validation, if the hash recorded in any specific block does match the result of hashing the previous block, that block doesn't belong there and the blockchain being evaluated is corrupted or fraudulent.

Aside from using hashing to validate the legitimate sequence of blocks, hashing can also be used to validate the content within blocks. Unlike sequenced blocks on the nested hash chain, hashed data of transactions contained within a block are not sequential but hierarchical, with each hash linked to its parent following a parent-child tree-like relation with the most populated hashed transactions comprising upper branches of “leaf” entries. Also depicted in FIG. 1, this hierarchical arrangement referred to as Merkle tree 13 comprises binary paired hashes 9a, 9b, 9c, 9d, 10a, 10c, and root 11 that can be scaled for 2, 4, 8, 16, 2^{m-1} elements (excluding the root) for any tree having m≥2 tiers. Beneficial features of a Merkel tree include:
The ability to determine the integrity and validity of data in a hierarchical database
The ability to confirm the integrity of a specific tree branch even if portions of the tree are damaged or not yet available
Lightweight, adding only minimal data overhead
Allows branches to be verified without inspecting the entire tree
Requires only small amounts of memory to perform validating proofs
Results in minimal network traffic during a validation
   Merkle trees are created by repeatedly hashing hash pairs until only one hash remains. In the block encoding process, transactions are hashed starting with individual instances (actually at the top of the hash tree), e.g. hashing blocks containing content A, content B, and content C. Because there is no content D to hash (i.e. D is a null entry) and binary hashing requires hash-pairs, to maintain binary leaf symmetry H_{D} is made a duplicate of the H_{C} hash.

H_{A}=H[content A]

H_{B}=H[content B]

H_{C}=H[content C]

H_{D}=H[content C]

The hashes are then paired, concatenated (or merged), and hashed again in repeated fashion until a single hash remains. Using ∥ to denote concatenation, the hash pair H_{AB} and H_{CD} are given by

H_{AB}=H[H_{A}∥H_{B}]

H_{CD}=H[H_{C}|H_{D}]

This action describes the hash processing executed one layer below the leaf layer. If more than two hashes remain forming an intermediate layer, the process is repeated until only two hash files remain. The final hash, referred to as the Merkel root H_{MR}, hashes these remaining two hashes:

H_{MR}=H[H_{AB}∥H_{CD}]

The Merkel root 11 therefore represents a singular unique hash of all constituent hashes in the tree. By including this Merkel root in sub-header 7 of header 3 in block 2c and similarly in every block of a blockchain, a quick check can be used to confirm block integrity throughout the tree. If the hash of the block doesn't match the Merkel root in the header, the content of the block has been tampered with, meaning the block may contain fraudulent transactions or a corrupted smart contract.

Importantly, hashing provides a means for a validation node or miner to confirm the veracity of a pending block before installing it onto the chain. But how can the juror nodes be trusted? Ensuring sincere validation is yet another role of cryptography in blockchain processing. To avoid the risk of a corrupted authentication, validating a transaction and recording it is performed by a consensus mechanism, a process of voting by an anonymous jury-of-peers. Since the juror nodes in the blockchain's network are unaware of the identity of the parties involved in any transaction they are validating, there is no logical motivation for the jurors to cheat or vote prejudicially when evaluating the integrity of a new entry.

Although nodes can vote without doing a thorough job vetting hashes, jurors exhibiting a chronic history of disagreeing with other nodes are suspect and ultimately removed from jury consideration. Another means to discourage improprieties among miners validating transactions is to employ a mechanism of proof. In one such concept (Proof of Work), each block header includes the hash of a random number called a nonce, a cryptography term meaning a number used once. Borrowed from the field of trusted communication, by introducing randomness into transactions a nonce is used as a form of authentication to prevent replay attacks, thereby preventing outsiders from executing a hack by guessing the next action from the last. In order to gain the opportunity to validate (mine) the block, the validator must first extract the nonce value (a random number having an varying number of leading zeroes) by solving the hash-nonce puzzle.

This brute force effort requires using energy and spending money thereby discouraging insincere effort or fraudulent results. In PoW implementations, these same hash-nonce puzzles are used to mine new cryptocurrencies. In addition to validating blocks, cryptography may also be used as credentials for confirming the authenticity of the content itself, e.g. art, music, tickets, etc. a feature especially important in trading non-fungible tokens. By employing cryptography in block confirmations and digital signatures, a blockchain is able to confer to users “trust in a trustless environment”.

Blockchain Properties: Properties of a blockchain include the following key features and characteristics:
Trusted. Since every node in a blockchain's network contains a copy of the same digital ledger, there is no means by which to insert a false entry without the fraudulent block being detected and expulsed from the network. In this manner, fraudulent transactions and corrupted blocks are never recorded on the blockchain.
Immutable. Once an entry is time-stamped and recorded on the blockchain it cannot be removed or re-sequenced^{[60]}. Indelibly recorded in the blockchain there are no means by which history and chronology of the blocks can be rewritten and corrupted ex post facto.
Decentralized. By employing a network of anonymous nodes to realize the blockchain's autonomous virtual machine, no central computer or network operator is in control of the blockchain's activities. As such, there is no single device or node vulnerable to cyberattack; no operator to bribe or coerce; and no private information to abscond.
Decentralized peer-to-peer networks are able to avoid manipulation and repel distributed denial-of-service (DDoS) attacks because would-be hackers cannot identify which servers in the cloud are hosting the various nodes in the blockchain's virtual network.
Redundant. The digital ledger forming the blockchain is shared across multiple nodes in the network eliminating any single point of failure or concentrated vulnerability. This parallel nodal structure provides data, network, and computing redundancy.

Benefits of a redundant distributed virtual machine include timely and confident resolution of transactions and tasks, even when nodes or its communications network go offline. An early example of redundant computing with juror-based decision making was the computer used to control NASA's space shuttle.

A decentralized redundant network should, however, not be confused with distributed computing. In distributed computing, a task is divided into separable pieces and assigned to each node to do its fair share of the work. By paralleling the effort, the time to complete a task is reduced in proportion to the number of nodes contributing to the task. Likewise the total energy consumed to perform the compute job E_{job} is spread across the virtual machine having “n” nodes, where each node consumes an average energy of E_{job}/n per job.

In contrast, in decentralized computing. a single task or job is identically performed in parallel by “n” network nodes operating in unison as a redundant array of compute nodes. As such, the time required to perform a job is not reduced at all by the virtual machine's redundancy. In fact, in decentralized computing the slowest speed node in the network determines the transaction rate of the blockchain's virtual machine. Moreover the energy required by decentralized computing increases from E_{job} consumed by a centralized computer to n·E_{job} in its decentralized version, meaning decentralized computing is less energy efficient than a central computer, not more so.
Consensus Validated. A key element of redundant systems is the means to arbitrate disagreement among its nodes, i.e. what to do when the nodes cannot come to a unanimous approval on whether a new transaction is valid. Decision making during conflict is facilitated by voting in a jury-of-peers using a consensus mechanism^{[64]} to tally the results of multiple nodes performing the same tasks. The requisite consensus criteria for passing or rejecting a pending transaction varies by a blockchain's implementation.
Consensus attacks [(such as a Sybil attack) used by hackers to corrupt voting can be repelled using randomized anonymous nodes and a variety of camouflage techniques to obscure juror nodes.

Proof. A key concept in implementing reliable consensus determinations is the means by which to ensure all participation nodes are sincere, i.e. that their vote is verified to be meaningful. Verifying a node is a sincere juror is called “proof”, although a more insightful description of keeping a node honest should be called proof-of-sincerity. But how can a blockchain virtual machine ensure its nodes are acting sincerely on the best interests of the blockchain's integrity and its user community?

The first step toward ensuring transactional integrity is to protect the identity of the parties participating in a transaction, thereby preventing the validators from engaging in conspiratorial or prejudicial voting, or “gaming” the system, i.e. intentionally committing malfeasance.

Common means by which proof is achieved to thwart corrupted voting is by ensuring that a juror node either has something to lose if they vote insincerely or dishonestly, e.g. that (i) they must have either spent money and effort to participate in the validation process (“Proof of Work”)^{[67]}, (ii) the value of assets they themselves hold could be adversely affected by their actions (“Proof of Stake”), or alternatively (iii) that the juror node holds certain credentials authenticating them as a participant whereby they only earn remuneration by consistently voting with the majority (without knowing a priori what the majority vote is).

First deployed as part of the Bitcoin blockchain and then later adopted by Ethereum, Proof of Work (PoW) intentionally wastes electricity as an necessary expense to mine new blocks. Spending discourages malfeasance or mischief by making such exploits cost the hacker money they can only recover so long that they are not disqualified for bad behavior. Recently, PoW with its horrendous carbon footprint has come under intense global scrutiny as being energy wasteful, environmentally irresponsible, and ecologically unsustainable. Alternative, greener methods such as Proof-of-Stake are now being adopted.

Migration to Proof-of-Stake (PoS) has however, been much slower than projected, in part because users aren't convinced that the nothing-at-stake problem can be avoided, a malicious deceit where a node misleads other nodes that it holds significant economic interest in the native cryptocurrency of a blockchain when in fact it doesn't. In PoS consensus voting, ineligible nodes if undetected can commit fraudulent transactions (such as double spending) or intentionally subvert valid transactions. Other options include credential-based consensus validations involving time-stamped “Proof of History” (PoH) or the HyperSphere's “Proof of Performance” (PoP), a decentralized consensus algorithm employing dynamic node governance and inimitable cryptographic hop-codes (a type of nested hash chain referred to as a transient blockchain).

These newer consensus algorithms, in addition to improving transactional speed, offer substantially smaller carbon footprints and improved resilience to hacking compared to their predecessors. In fact, the HyperSphere hop code generates cryptographic proof of a node's contributions as part of the network moving data and doing real work—energy that would have been used even if no consensus validation was involved. In other words, PoP validations can be executed as part of packet communication without consuming any additional energy.

But because of their intrinsic differences, these newer consensus mechanisms cannot be retrofitted into extant blockchains, and instead must be built into a blockchain's architecture at its inception.

Security. As described previously, cryptography provides security to the blockchain and its transactions in numerous ways including authenticating the integrity and provenance of blocks on the chain and facilitating a means by which new blocks, once confirmed, can be appended onto the chain. Cryptography also enables verification of a block's Merkel tree to ensure its contents have not been altered, thereby preventing double spending, fraud or tampering with a smart contract.

Using hash-nonce puzzles or security credentials issued via a blockchain virtual machine, cryptography is used to confirm the sincerity of juror nodes involved in approving transactions. Through private keys, cryptography protects the assets stored in decentralized wallets and transacted through smart contracts. Using digital signatures, the authenticity of an asset can also be verified, an especially important feature for trading collectables using non-fungible tokens (NFTs).

While blockchain transactions are protected cryptographically, network communications over the Internet are still exposed to surveillance, metadata analysis, phishing exploits, and malware. Transactions executed via Internet browsers, unsecured wallets, and badly designed protocols remain particularly vulnerable to attacks designed to abscond a user's private encryption keys. To thwart such hacks, an added degree of blockchain protection can be achieved by altering network communication, specifically by obfuscating or encrypting packet data on OSI layers 3, 6, and/or 7 (i.e. network, presentation, and application layers respectively)—methods unique to the HyperSphere.

Unlike the mining and validation of passive cryptocurrency vulnerable to DDoS and consensus attacks, the hard-coded instructions of a smart contract (once uploaded to the blockchain) are immutable. Thus limited, a cyberhacker can only interfere with smart contract execution by operation of the blockchain's virtual machine (BCVM) hosting it or by disrupting the system's state machine, e.g. using time jacking, reentrancy, etc. The risk of DeFi cyberattacks is amplified by badly written code, greatly increasing the attack surface of smart contracts exposed to hacking. To prevent such risk exposure an exhaustive review by trained dApp and cybersecurity experts is required.

Transparency. Decentralized unitary blockchains such a Bitcoin and Ethereum are public, providing open inspection of block entries and transactions. Public unitary blockchains facilitate tracing genealogical history of transactionally related addresses including wallets, digital assets, and smart contracts. Downloads of permissionless smart contracts also enable inspection of smart contract code by authors, users, and accredited 3^{rd} party validation services. The downside of the transparency of public unitary blockchains is their susceptibility to various attacks including backtracing of high value wallets. Fortunately wallet addresses, although public do not disclose the wallet's owner's true identity.

Transaction Speed. The speed of a blockchain depends on its validation mechanisms and on its temporal and hierarchical structure^{[79][80]}. Proof of Work is, for example, significantly slower than Proof of Stake, which in turn is slower than Proof of History and Proof of Performance. Single public unitary blockchains are intrinsically slow and degrade in their transactional throughput the larger (i.e. longer) the chain becomes. Parallel chains like DyDAGs have to the ability to deliver higher transaction rates because shorter chains with fewer blocks can be checked more quickly and with a greater degree of parallelism.

When executing a smart contract containing logic and arithmetic calculations, the operations per second (OPS) rate becomes a critical factor in smart contract execution time. In most implementations, blocks are mined, i.e. transacted, in fixed intervals called block time specific to the blockchain's network. For example, Ethereum previously ran with a block time of 15 seconds and in 2012 reduced its block time to 12 seconds. Newer competing chains are faster, with block times as short as 2 seconds. By contrast bitcoin, a first generation blockchain takes 9 minutes to resolve a block. To perform the same amount of work in less time requires higher speed computing. But since a blockchain doesn't control the hardware its miners or validators use, it cannot stipulate the hardware or a minimum performance level for nodes in its networks. Since all transactions are time-stamped upon the block's recording on the chain, a means to measure and monitor a network's evolving performance already exists. A simple statistical analysis of recent chain transactions immediately reveals current processing times of the blockchain's community of nodes. Improvements in computing performance, i.e. miners buying faster processors, are thereby manifested statistically in transaction rates even though the particulars of computer architectures and GPU semiconductor technology nodes being used are unreported. As such, improvements in network performance can be adjusted to reflect ever improving performance for any specific BCVM.

Increasing a decentralized network's performance criteria does however carry risk^{[82]}. As blockchain specifications are upgraded, the network unavoidably becomes controlled by an increasingly smaller population of more capable compute nodes that only wealthier miners can afford, thereby threating node diversity and decentralization. The other key factor deciding the arithmetic OPS rate is the block size. Rather than measuring blocks in terms of bytes, block size is measured by the maximum amount of gas allocated for a block. Since gas is a unit of measure for the computational effort required to execute certain operations, the gas limit measures a block's maximum computational effort, where gas required per operation is specified by gas consumption rate G, and where

$$OPS = \frac{Gas Limit}{G \cdot Block Time}$$

For example before its gas limit and OPS rate increase in April of 2021, the EVM had a Gas Limit of 12.5M, a 12 second Block Time, and a consumption rate G=3 per fixed integer operation ^{[85]}, so that

$$OPS = \frac{Gas Limit}{G \cdot Block Time} = \frac{12 , 500 , 000}{3 \cdot 12 sec} \approx 350 k ops / sec$$

This instruction processing rate is quite slow by computing standards, being comparable to that of the IBM System/360 computer of 1965. By contrast, today's readily available graphics processors for gaming perform floating point (not fixed integer) calculations at rates of 30 TFLOPs, eight order-of-magnitude faster than EVM based dApps. While it may appear obvious to improve throughput, the gas limit can be increased to accommodate larger blocks, the risk that a significant number of nodes will be unable to complete the job within the allocated block time grows exponentially with linear increases in block size. Incomplete block validations must be discarded and repeated, thereby increasing gas fees and delaying the completion of a smart contract's transaction.

Smart Contracts (dApps): Rather than simply storing passive data, 2^{nd} generation blockchains (and beyond) support decentralized applications (dApps) called smart contracts. A smart contract comprises software-based if-then-else conditional logic able to react to changes in state variables specified in the contract including time & dates, trades, prices, token supplies, and prior transactions. Smart contracts can also perform fixed integer arithmetic operations, but cannot perform floating point calculations.

Blockchains enable smart contracts in several ways including (i) providing a decentralized platform to store and distribute dApps to users, (ii) facilitating a live database recording transactions as updates to the newest most-current instance of the contract, (iii) providing a consensus mechanism to validate new contract instantiations, and (iv) operating as a blockchain virtual machine (BCVM) needed to execute smart contract instructions.

Inspired by the concept of decentralization first demonstrated by the file sharing program BitTorrent combined with a deep appreciation in the frugal application of distributed processing using nodes of limited computing capability (i.e. performance comparable to ES-EVM), the notion of an “unstoppable computer” lacking any dedicated hardware platform was born. This pioneering proof-of-concept in decentralized applications, the Ethereum Virtual Machine or EVM, proved to be far more impactful than anyone could have foreseen.

In fact, the fundamental design of nearly all blockchain virtual machines remains essentially unchanged from its Ethereum blockchain progenitor. Architecturally, as depicted in FIG. 2, the Ethereum virtual machine (EVM) operates as a state machine comprising a lightweight decentralized application stored on the Ethereum blockchain able to perform varying degrees of computing applications with no dedicated host processor.

As depicted, realization of an Ethereum virtual machine comprises three elements, namely (i) an immutable dApp 20a comprising EVM code 21 stored on the blockchain; (ii) a world state σ 20b maintained in an updated yet persistent state as “account storage”; and (iii) a machine state μ 20c comprising a volatile instance of the Ethereum virtual machine existing temporarily during transactional processing.

The computing kernel of EVM comprises software stored on the Ethereum blockchain as the EVM's operating system. Using the blockchain as virtual read only memory (virtual ROM), this EVM OS code 21 cannot be revised or edited except by launching updates as entirely new instances on the blockchain. Even then, the prior version remains perpetually available. In this manner, the Ethereum blockchain functions as a trustworthy platform to distribute software, in this case the Ethereum Virtual Machine. To invoke the EVM, a smart contract written in the Javascript like language called Solidity make a function call to the EVM OS.

Upon its launch on the Ethereum network of nodes, the EVM OS collects variables data from its designated decentralized account storage representing a world state σ. Loading this data into the EVM allows the system to catch up with the events that occurred during its hibernation, i.e. to make it current. For example, if a number of tokens were sold via a smart contract as the last recorded transaction before going dormant, this available supply data is transferred from account storage into the EVM OS as a starting point for processing.

Data in the account storage 26 is filed sequentially in key-value pairs comprising a cryptographic key 32-bytes wide identifying each state variable 27a and a corresponding current value of the data 27b, also 32B wide. Because this data is always loaded from account storage 26 when booting up the EVM OS and rewritten at the commencement of a job, the world state μ data is described as “persistent”.

At the heart of EVM OS executable code is its machine state μ 20b, a clocked state machine comprising a program counter 22, a gas gauge 23, a program stack 24, and scratch pad memory 25 operating as virtual RAM. During EVM launch, operating instructions are loaded from virtual ROM while present state information is loaded from account storage. Transfers into the state machine occur in 32B data bursts and stored in either 1B wide memory or pushed onto the 32B wide program stack. The machine state μ is volatile, and does not survive beyond execution of a smart contract except via data written to storage as world state σ 20c.

Like RPN-based programs and calculators, the program stack in machine state μ comprises a mix of data and ordered operating instructions, executed sequentially with each advance in the program counter. Completed operations are “popped” off the top of the program stack as execution continues until either the task is complete or gas runs out. Careful programming of smart contracts for the EVM state machine is warranted to avoid transactions exceeding the maximum allowed block size. Block overflows produce a fault condition leading to permanent loss of the mining efforts for the block, failed program execution, incomplete transactions, and possibly indeterminate states. Looping, hold states, and floating point arithmetic operations are also forbidden as there is no way to determine a priori if the program step will compete or exceed the Gas Limit or Block Time.

Finally special care must be given to ensure smart contracts executed on the EVM are confirmed to be bug free. Operations writing data to an improper address or contracts stuck in a suspended state can lead to an unrecoverable loss of assets.

Operation of the EVM is only exemplary. The implementation of any blockchain virtual machine is chain specific employing different implementations, languages, protocols, and consensus mechanisms^{[90]}. Live chains include BSC Binance smart chain, Huobi ECO chain, Solana, Polkadot, Cardano Ouroboros, HyperLedger, Tezos, Stellar, EOS, IOTA Tangle, and others. Some of the foregoing blockchains actually comprise blockchain platforms for hosting client customized virtual machines and networks.

One such platform is HyperLedger, an umbrella project for open-source blockchains of the Linux Foundation with major backing from IBM and SAP-Ariba. Frameworks developed atop HyperLedger include Hyperledger Fabric, Hyperledger Iroha, Hyperledger Sawtooth, and Hyperledger Besu plus a large array of developer tools.

Another platform for blockchain development is Polkadot. Created by Ethereum cofounder and developer of Solidity, Gavin Wood, Polkadot is intended as a development ecosphere for blockchains. An integral component of this system is Relay-Chain, an integration tool supporting network interoperability of parachains, parathreads, and sharding, methods allowing developers to create their own blockchains supporting customized governance and tokens while supporting rapid processing and high transactional throughputs.

One such smart contract platform developed on Polkadot is Moonbeam, an Ethereum compatible network allowing developers to deploy existing Solidity-based smart contracts and associated dApps to Moonbeam without major changes. By porting Solidity dApps to Moonbeam on Polkadot, purported beneficial performance improvements over Ethereum hosting include reduced costs and higher transactional throughput.

Smart contracts also play a special role in creating, distributing, and trading digital assets called tokens including both fungible and nonfungible tokens (NFTs) described here below.

Crypto & DeFi Transactions. Blockchains support a variety of digital assets and their transactions. Example include chain-native cryptocurrencies like BTC and ETH, fungible utility and security tokens such as USD [symbol] for a variety of funding, investing and commercial purposes, and non-fungible tokens (NFTs) used for acquiring and trading collectibles with limited edition content. A smart contract enables unrelated parties to engage in shared activities such as trading (swapping), lending (staking), borrowing, and market making (liquidity providing). It can also be used to autonomously generate new token offerings.

Like a group of individuals pooling money to buy lottery tickets together as a collective, a smart contract can be used to anonymously pool investments from a group of unrelated investors and venture capitalists to jointly fund a project; invest in or fund an index or synthetic fund; or capitalize a DAO or corporation. A smart contract enabling shared investment from unrelated parties is referred to as decentralized finance pool, a DeFi pool, or a liquidity pool^{[100]}. The DeFi pool is virtual and decentralized, not physically existing in any one server, device, website, storage device, or located in a specific country or domicile. A DeFi pool is therefore simply a smart contract shared by investors.

The platform or website hosting and granting access to the DeFi pool is not a participant in the pool. Existing at arms length from the pool's operation, the host platform is nothing but a link or user interface (UI/UX) created to access the pool's smart contract. All terms and conditions for the pool are defined by its smart contract not its platform. As such, no platform or device has any control whatsoever over the terms and conditions of trading in the pool and among its participants. A DeFi pool therefore is peer-to-peer (P2P) commerce.

Tokens created by the smart contract are autonomously generated algorithmically by, for, and on behalf of the pool's participants. Except in the case of a corporate token offering, tokens issued by a DeFi pool in a token generation event (TGE) have no issuer. Since there is no issuer, a TGE does not meet the legal definition of a securities offering. This subtle but important distinction that token issuance without an issuer does not constitute an “offering” will remain a hotly contested legal matter for the foreseeable future.

Because there is no central authority able to regulate autonomously executed smart contracts, investors and token traders are advised to consider DeFi trading in the context of caveat emptor (buyer beware) and to take extra precautions to ensure that a smart contract is bug free and its DeFi pool represents a legitimate project or development. In the case of corporate offerings, a appropriate degree of due diligence is advised, the same as suggested in the case of buying private and public equities.

Cryptocosm Summarized: Given the foregoing in-depth discussion, several major high-level take-aways can be surmised.
1. The blockchain provides a decentralized ecosphere for engaging in peer-to-peer financial transactions and record keeping without the need for governing control by a central authority or financial institution. Blockchains are therefore unavoidably disruptive (possibly beneficially or detrimentally) to the banking and financial services sector.
2. Arranged into a linear sequence of finite-sized digital blocks, transactions on the blockchain are indelibly recorded using cryptography to create new entries and consensus mechanisms involving a jury-of-peers to confirm the veracity of existing block entries.
3. Entries on a blockchain may include passive components such as data, ledgers, records, and chain-native cryptocurrency (BTC, ETH, etc.) as well as smart contracts comprising decentralized application dApp software.
4. Decentralized applications and smart contracts can be accessed, downloaded, and executed (called) directly from the public blockchain with no risk of tampering to its source code. Third party expert validation and certification of a smart contract's quality and integrity is commercially available and recommended.
5. The execution of a dApp occurs not on a private website (at risk to hacking) but on a cloud based blockchain virtual machine (such as Ethereum's EVM) able to complete transactions through decentralized networks having no dedicated hardware or devices.
6. Because of risks of typographical errors, bugs, and poorly written logic, arithmetics, and function calls unavoidable in manual smart contract code writing, autonomous dApp software called protocols are employed to synthetically generate smart contracts following defined algorithms. Protocols too must be carefully checked and fully vetted.
7. One major class of dApps involves the use of smart contracts to create, issue, trade and hypothecate DeFi tokens. Tokens offer numerous beneficial features not available with passive chain-native cryptocurrency such as those created through crypto mining efforts.
8. DeFi tokens sharing a common smart contract are referred to as a DeFi pool. When sponsored by a token issuer such as a corporation, DeFi pools may be used to launch new tokens into the market. Alternatively DeFi pools funded by liquidity providers operate as autonomous marketplace for trading or lending of pre-existing virtual currencies and non-fungible tokens. A DeFi pool exemplifies peer-to-peer (P2P) commerce.

What Are DeFi Tokens?: Broadly speaking digital tokens are cryptographic tokens created by the execution of a smart contract on a public or private blockchain. Such tokens can be
Issued as centralized virtual currency (digital money) by governments using a tightly regulated permissioned blockchain,
Issued by a corporation or NGO (non-governmental organization) as a non-financial token for identity, access privilege, or gaming using a private permissioned blockchain,
Non-fungible tokens (NFTs) issued by artists and gamers as collectables and as virtual assets in the metaverse,
Issued as fungible DeFi tokens comprising a decentralized tradable asset using a public permissionless blockchain.

The first two examples, government issued digital money and private access tokens are not decentralized and therefore beyond the purview of this whitepaper. The third bullet, non-fungible tokens comprise their own DeFi token class. Unlike fungible tokens which comprise a population of indistinguishable digital tokens of equal value useful in commerce, non-fungible tokens exhibit properties of uniqueness, identity, and ownership (royalty rights).

Trading of NFTs in various blockchain specific marketplaces and communities requires extensive cross-chain transactions whereby gas fees, not utility, become a significant factor.

The fourth bullet, decentralized fungible digital assets known as DeFi tokens represents an enormously broad and expanding asset class. Deployed on public permissionless blockchains, DeFi tokens are generated not by puzzle solving, but by executing smart contracts—dApps hosted on one or more blockchain virtual machines (BCVMs).

One distinguishing difference between DeFi tokens and cryptocurrency is their “total supply”. Unlike cryptocurrency where new coins can be mined at any time (even at a loss), the total supply of a token at its launch is fixed in quantity and cannot be adjusted afterwards. DeFi tokens come in a variety of forms including:
Cryptographic wraps of fungible tradable cryptocurrency (such as WETH)
Stablecoins comprising fungible tradable tokens having value pegged to real world assets such a fiat money, gold, etc.
Fungible tradable tokens issued by a corporation or entity
Fungible tradable tokens issued autonomously by and for a DeFi pool

Crypto Cash Equivalents: The first two bullet items, i.e. cryptocurrency wraps and stablecoins, (herein referred to simply as “crypto”) operate as crypto cash equivalents in the cryptocosm. These assets have a defined value at the time of a trade and therefore can be used in swapping a publicly tradable asset of defined value for a private or publicly traded token of speculative future value. The worth of crypto cash equivalents at the time of a DeFi token trade are well defined by high-volume global markets. Some tokens are further collateralized by non-cryptographic assets such as gold or fiat currency to combat volatility. Such tokens, referred to as stablecoins, carry value pegged to its fungible counterpart.

For example, Tether is a stable coin pegged to the United States dollar whereby value {1 USD [symbol] }≈value {1 $USD}. Stablecoins bridge the token and cryptocurrency worlds as they may be traded on digital currency exchanges and also be used in the autonomous execution of a smart contract. In the commercial press, stablecoins are often incorrectly referred to as cryptocurrency (akin to BTC and ETH) because they perform the functions of storing value and transacting commerce. Stablecoins are not however chain-native cryptocurrencies, they are tokens, which is the reason why they can be used in smart contracts without first wrapping them (when BTC and ETH cannot).

For example, the US dollar based stablecoins USD [symbol] , USDC, DAI and BUSD are pegged to the United State dollar at fixed 1:1 conversion ratio (within some small slippage range). Other stablecoins are now being issued pegged to the Euro, the British pound, the Japanese Yen, and the Singapore dollar. In the case of a highly-traded volatile currency like ETH, its cash equivalent value varies constantly. As such, during any DeFi transaction, the Ether must be valued at its “spot” trade price—its market value frozen at a specific moment or window in time. To avoid any misunderstandings, a particular public digital currency exchange, e.g. Binance, is specified as the exchange on which reference trading price is based.

Chain-native cryptocurrency like ETH suffers several disadvantages compared to tokens. Firstly, they are locked to their own blockchain and are not interoperable across chains. Secondly, they are not ERC-20 compatible meaning they cannot be used to transact trades by smart contract. Thirdly, as a liquid, tradable, and fungible cryptocurrency they cannot be locked or held as collateral except by transferring them to a custodial wallet (wallets having private keys controlled by another party).

The solution to this quandary is tokenization—converting chain-native cryptocurrency into tokens. The token conversion process, turning fungible assets into smart-contract compatible tokens, is performed prior to engaging in any dApp based commerce, and therefore does not affect real-time transactional throughput. The process of tokenizing cryptocurrency is called “wrapping”. Token wrapping involves locking an asset into a smart contract and generating a specified number of corresponding tokens. The aggregate worth of these tokens at inception equals the value of the underlying asset securing the tokens. Token wraps are thereby mirrors of the underlying asset used to create them, whose value depends on the asset collateralizing the token and on the quality of the smart contract used to create them. Token wraps are therefore also called tokenized cryptocurrency.

Any crypto asset can be wrapped. Token wraps of cryptocurrency are frequently identified by attaching the prefix “W” to the cryptocurrency's symbol name. For example WETH is any wrap of Ether, WBTC is Bitcoin wrap, and so on. For convenience, token wraps are generally issued on a 1:1 basis with their underlying asset and maintain a constant price ratio despite market fluctuations in the asset base's value. In other words, if the price of ETH rises, so too does WETH.

For example, the value of Bitcoin wrap is equal to the real-time value of Bitcoin, price {1 WBTC}≈price {1 BTC}. Similarly on the Ethereum network, price {1 WETH}≈price {1 ETH}. Because the price ratios of tokenized cryptocurrencies are fixed relative to their underlying assets and since it is generally understood that a smart contract can only transact tokens, it is commonplace to exclude the W prefix when referring to wrapped cryptocurrencies, and to casually refer to cryptocurrencies and their token counterparts as equivalent.

The process of tokenizing an asset through wrapping involves execution of a smart contract. In the process of wrapping shown in FIG. 3, the value of investor 30 assets 34a in wallet 31a collateralizing the token is first locked 34b by a smart contract 34a and recorded on the blockchain 33 as the new owner address. Thereafter, smart contract 34b issues the corresponding token or tokens called. token wrap 35 at a fixed ratio, the issuance to wallet 31b of which is recorded on the blockchain network hosting the smart contract. Unwrapping of a token simply reverses the process, surrendering the token and releasing the asset. Since many smart contracts are written in Solidity to be compatible with the Ethereum blockchain and EVM, ETH and numerous versions of genericized WETH form natural token-wrap pairs. Compared to transacting chain-native cryptocurrency (ETH, BTC, etc.), the benefit of using token wraps on a smart-contract enabled blockchain are numerous including:
Conditional transactions. Using smart contracts and blockchain oracles, token wrap based transactions can be executed conditionally in response to changing market and economic conditions.
Increased transactional speed. Smart contract validation of token wrap transfers is simpler and faster than manually executing trades via chain-native cryptocurrency, transactions demanding laborious block-by-block validation and juror consensus by all nodes.
Greater transparency. Using token wraps, smart contracts provide superior transparency facilitated through unrestricted blockchain public access specifying token governance and transactional statistics (e.g. number of tokens outstanding, created, transferred, burned . . . )
Interoperability. Token wraps are interoperable across a vast range of wallets, exchanges, and dApps and uniquely adapted to transact with assets on any fork (network) of the Ethereum blockchain. WBTC enables Bitcoin payment or swaps to be executed using Ethereum base smart contracts otherwise incompatible with Bitcoin transactions.
Portability. Token wraps can be used to facilitate cross chain trading by launching affiliated smart contracts on two or more blockchains
Expanded applications. Smart contracts facilitate a bridge between token economics and real world applications such as robotics, security, and IoT.
Enhanced security. Tokenization enables users exclusive access of an asset's private keys.
Policy enforcement. Tokenization provides a mechanism to enforce policies on-chain, providing transparent regulation while preventing single-party control abuse, manipulation, malfeasance, or asset misappropriation.

Technical standards for token wraps vary but generally mandate the method in which tokens are transferred and how users can access data regarding a particular token. The standards specify the minimum required token data need to facilitate trade analytics, exchange tokens, or to transfer them into or from a crypto-wallet. The Ethereum blockchain, for example, supports a number of technical standards for tokens, the most common one being ERC-20 comprising a standardized API^{[104]} used for fungible tokens including transfer, payment, and balance-tracking functionalities. The acronym ERC, meaning Ethereum Request for Comments, refers to information requests, i.e. data exchange, needed to successfully process pending token transactions.

Fungible DeFi Tokens: The generation of fungible tokens by smart contract hosted on a permissionless blockchain provides a means by which new tokens are created without the need for mining and wrapping existing cryptocurrency. In this regard, executing a smart contract to generate tokens is ecologically sustainable (green) compared to PoW cryptocurrency mining. During the token generation process, a smart contract is authored specifying the type and quantity of tokens to be minted, then executed by uploading the smart contract to its intended host blockchain.

Once generated, DeFi tokens are sold (swapped) to investors. Concurrently, or in phases, the purchased tokens are distributed to investors through a process called a token launch. DeFi token launches may be executed on behalf of a variety of token sponsors, including
A corporation, registered business, or DAO
A project or dApp development
A trading pool (a consortium of traders)
An artist or content creator

Proceeds of token sales are directed to its sponsor which in turn has an implicit (or explicit) obligation to deliver a product or service for investment received. For example, a corporation is obligated to deliver a product or service; a project is committed to deliver working software or dApps, a trading pool is obligated to deliver a means for people to swap, stake, or borrow a specified lists of tradable assets, and an artist must deliver their creative works (or rights thereto) to collectors. Token offerings lacking defined deliverables are considered scams or fraud.

Since the tokens are issued via a permissionless blockchain, the crypto-economy considers the token launch as decentralized finance. Token distribution during a launch can be executed in a variety of mechanisms, namely
Through private sales (and/or SAFT agreements) to venture capital (VC) funds
Through airdrops (free gifts used for marketing purposes)
Through exclusive IDOs (Initial DEX Offering) on select decentralized exchanges
Through private presales to accredited investors (pursuant to KYC and regulations)
Through a token generation event (TGE) on one or more DEXs or centralized DCXs
Through a government approved whitelisting via a DEX or a centralized DCX

In all of the above cases (but airdrops), token distribution is limited to professional investors who have passed rigid KYC/AML verification generally as executed by a decentralized exchange (DEX) or a centralized digital currency exchange (DCX). General partners and investors in venture capital (VC) funds are also considered as qualified professional investors. Suspiciously absent from the foregoing list is an initial coin offering or ICO, a process analogous to a initial public offering (IPO) for equities where a company sells tokens directly to the unqualified public.

Following a brief but intense period of ICOs between 2017 and 2019, courts ruled that many ICO token issuances represented unlicensed public security offerings. It was also determined that many issuers failed to perform sufficient identity verifications to confidently establish candidates as accredited investors. Expectedly, token sales made directly to the general public are now considered verboten in many countries and jurisdictions.

Even so, out of a preponderance of caution, many companies issuing tokens restrict their distribution, excluding nations banning or limiting the sale of digital assets and cryptocurrencies such as the United States of America and its territories, Canada, the United Kingdom, and the Peoples Republic of China (including Hong Kong). Investors should be mindful as to applicable laws in their country of citizenship and residence.

As a final point it would be remiss not to mention that the act of creating new tokens does not by itself represent a token generation event. There is no requirement to issue generated tokens at the time of the token's genesis event. In fact, there is no requirement to ever distribute them. For example, an engineering project seeking funding through a DeFi token offering may, for whatever reason, change plans and cancel their offering, generating but never distributing their tokens. If so, the smart contract goes abandoned, and perpetually persists on the blockchain without ever executing a token sale or a single transfer.

DeFi Token Standards: To ensure ubiquitous interchangeability, fungible DeFi tokens must comply with agreed standards specific to a blockchain. Two of the most common standards include Ethereum's ERC-20 standard and Binance's BEP-20 standard. These standards specify key factors determining an offering's tokenomics. The ERC-20 standard for Ethereum specifies six mandatory and three optional function calls of argument (*), namely:
totalSupply (*) describes a token's total supply, i.e. its total number in circulation
balanceOf (*) displays the number of tokens in an owner's wallet
transfer (*) specifies the amount of tokens to be sent and to what address
transferFrom (*) enables a smart contract to automate transferring a specified amount of tokens from the owner to the receiver
approve (*) approves withdrawal of a set quantity of tokens from the owners wallet by a receiving address
allowance (*) verifies the owner's wallet contains at least as many validated tokens as specified in the approve (*) instruction
name (*) optionally specifies the token's identity
symbol (*) optionally specifies a token's 3 or 4 letter abbreviation
decimals (*) optionally specifies the number of digits to the right of the decimal point when representing integers as fixed-digit numbers, a function required for fractional units of tokens (important when a token appreciates to an unusably high price)

ERC functions provide information needed for smart contracts to reliably perform prescribed tasks (such as transferring assets to wallets or to other smart contracts). Although tokens can be transferred directly using the transfer (*) function, sending digital assets manually implicitly carries risks. For example, transferring tokens to a smart contract incapable to receive them will result in irrevocable loss, one where the sent tokens will be credited to the receiver's address and the transaction recorded as “complete, but where the recipient's contract can't recognize them.

For exemplary purposes, numerous ERC-20 compliant tokens include Chainlink (LINK), Shiba Inu (SHIB), OmiseGO (OMG), EOS, Tron (TRX), ICON (ICX), Maker (MKR), Basic attention token (BAT), Ox (ZRX), Quant (QNT), IOT Chain (ITC), and Jasmy. The stablecoins Tether (USN), USDC, Dai, and BUSD are also ERC-20 compliant tokens. Ironically, the Ethereum blockchain's native cryptocurrency ETH is not.

Smart contracts using ERC-20 compliant tokens can reduce the risk of errors by invoking certain proofing and compatibility checks before executing a transaction, for example using the function calls approve (*) and transferFrom (*) transfer tokens pursuant to meeting defined criteria. Even so, ERC-20 compliant tokens are far from foolproof and subject to numerous failure modes.

To circumvent these issues, alternative token standards to ERC-20 have been developed including backward compatible ERC-223 designed to prevent loss of funds during transfers. Other notable options include ERC-721 for non-fungible tokens (NTFs), ERC-809 for renting rival NTFs, and ERC-1238 for non-transferable tokens or badges. Despite offering enhanced features and benefits, widescale adoption of these alternate token standards remains elusive, and ERC-20 retains its unrivaled hegemony on the Ethereum blockchain.

Similar standards, sometimes with extended features exist on other blockchains like BEP-20 on the Binance smart chain, and evolving standards on newer blockchain networks. It should be cautioned, regardless of the asset traded by smart contract transactions on a given blockchain network and BCVM, the gas required to fund the community of validators executing the smart contract is specific to each blockchain. So while execution of a EVM smart contract transacting ERC-20 tokens requires ETH for gas fees, execution of a BSC smart contract transacting BEP-20 tokens requires the Binance BNB token, not ETH for gas.

Features of Tokens: The value and utility of tokens are not simply intended to emulate a fungible replacement for fiat currency. Cryptocurrency can do that. As defined by their role, purpose, and features, tokens can do things that neither fiat nor cryptocurrency can. Tokens can, for instance, can carry state information, passing genetic-like credentials conferring privilege, rights, benefits, preference, privity, privacy, or access despite no direct involvement between transacting parties.

Like an exclusive golf club membership, tokens can enable unique privileges to their holders by granting access to products, content, or services unavailable without the token. For example, tokens issued to an entertainer's fan club members can enable preferred seating unique to their most faithful followers. Tokens can also be used to provide economic incentives to users, allowing them to receive discounts for purchases, earn gifts, or upgrade to a nicer hotel room.

For example, online music purchases using tokens may receive bonus songs not included in an album. Accumulating tokens may earn free online streaming services of movies or music. Similar to airline miles, tokens can also be used to access unused inventory (like an empty business class seat) at discounts or for free. Unlike air miles which are administered by an airline or group of carriers issuing the mileage, however, tokens do not involve staff or costs to administer or distribute. In DeFi, there is no central authority issuing tokens or controlling distribution.

Another uniqueness of fungible tokens is their indistinguishability. Tokens of a specific type (e.g. USD [symbol] , USDC, aIOT, UNI, YFI, etc.) are all identical in characteristics to all other tokens having the same symbol and therefore are indistinguishable from one another. A crypto wallet containing enterprise tokens cannot differentiate which tokens came from earlier purchases, which ones were acquired later at a higher price, and which ones were received free via a promotional distribution, i.e. a crypto airdrop. ERC-20 tokens do not carry an identifying code defining their identity or able to register its owner like stock certificates do.

Because of indistinguishability, tokens do not bestow personal ownership rights or involve identity registration. Tokens used for riding a train or bus do not have the rider's name on them. Anyone can use them. Accordingly, tokens offer the convenience of transferability, easily swapped among friends, bartered for favors, or donated for charitable purposes. Indistinguishability has one downside—it is impossible to determine if a token has been stolen and from whom. For this reason, the security and privacy provisions of crypto wallets holding tokens are of paramount importance to protect token assets from cybertheft.

Tokens can also carry economic value. Like chain-native cryptocurrency, ERC-20 compliant tokens created by wrapping a cryptocurrency (generically referred to as WETH), can be used in trading in crypto commerce in lieu of ETH or BTC. Unlike non-token cryptocurrencies, smart contracts enable tokens to facilitate conditional properties such as locking, pegged pricing, bonus awards, conditional releases, etc. not possible with pure cryptocurrency. For example, an airdrop of BTC enables its recipient to immediately trade their cryptocurrency while a token airdrop can remain locked for a defined time or until a specific condition is met. As such, tokens can be used to encourage behavior or incentivize long-term participation in a pool or business.

Tokens can also grant privilege—facilitating access to a product, service, or preference for its holder. Operating like a membership pass to participating businesses, a token holder can gain access to a venue, receive beneficial pricing, or request special privileges reserved for elite token types, e.g. access to a hotel's presidential suite, book a private box at a sporting event, schedule a post-show meet-and-greet with a performing artist, request an exclusive VIP table held in reserve at a 5-star restaurant, etc. As mentioned previously, tokens conferring benefits with undefined economic value are referred to as NFTs, an acronym for non fungible tokens. The benefits of NFTs, e.g. ownership, are not limited to non-cash transactions. Hybrid tokens may combine NFT features with embedded value.

Another unique capability of tokens compared to cryptocurrency is awareness. The trading of dumb cryptocurrency is unconditional. If the crypto coin is valid it can be immediately transferred or sold irrespective of economic conditions or the consequence of their trades. Tokens in contrast can solicit and consider off-chain conditions in managing transactions. By employing blockchain oracles to import information of on-chain and off-chain events, smart contracts can dynamically react, or using artificial intelligence even adapt, to changing economic and environmental conditions including prices, dates, volumes, etc.

For example, smart contracts can limit a token's use for services only in defined GPS regions or on specific cellular networks, thereby ensuring compliance with local legal ordinances. A smart contract may autonomously prevent or limit swapping (buying or selling) in times of volatile trading or price crashes. Conditional value is of particular benefit in commerce especially in realizing stable coins—tokens which maintain a fixed price ratio to a commodity (such as gold) or which are pegged at a pre-defined ratio to the value of a specific fiat currency. USD [symbol] for example is a token whose commercial price is pegged (within some nominal range) to the United States dollar (USD).

Transacting DeFi Tokens: DeFi token transactions occur in three major phases of an token's lifecycle, namely
Token generation
Token distribution
Token trading

Creating a new token, i.e. token generation, involves executing a smart contract defining the type and properties of the issued token. Smart contract authoring is a critical element in properly executing any DeFi offering as the launching of a smart contract live is an irrevocable event—once done it cannot be undone. Specifically terms of a smart contract cannot be changed after-the-fact and mistakes cannot be removed. The consequences of a badly written smart contract ranges widely from unnecessarily incurring users excessive gas fees to causing a complete loss of invested capital. Failure root-causes include arithmetic errors, logic errors, improper function calls, a stuck program counter (frozen states), incomplete or misdirected transfers, and more.

In essence, the tokenomics of an token offering and its execution are inexorably defined by its smart contract. The number of tokens generated, i.e. the token total supply, cannot be increased at a later date. Locked tokens cannot be unlocked unless the conditions specified in the smart contract occur, e.g. in accordance with a defined vesting schedule. Unlocked tokens cannot be locked after the fact and vesting schedules, once defined, cannot be altered. So the creation of a reliable error-free smart contract is fundamental to a successful token issuance. Smart contracts represent a particular type of software called a decentralized application or “dApp”.

Developing dApps: Writing new smart contracts is the role of a dApp developer, a team of software programmers familiar with blockchain-based decentralized applications. Decentralized application programming is significantly different than programming for a smart phone, personal computer, cloud server, web server, IOT device, or connected vehicle.

In conventional computing, the application program runs on top of an operating system which locally delivers dedicated resources including hardware comprising one or many compute engines, cache memory, and non-volatile storage. The hardware host resources are owned or leased by the software owner. When a user signs a service agreement with Amazon or Google web services, the contract is similar to a car rental in that the client owns the right to use the leased hardware for the specified term just as though they bought a server themselves, irrespective of which server in their cloud actually performs the tasks on any given time or day.

When a programmer has unlimited access to dedicated hardware, the software programs it hosts can be incredibly inefficient executing instructions that serve no purpose and storing data that isn't needed, because it simply is too small a concern to care about. Web programmers are particularly notorious for creating inefficient code based on pre-fabricated HTML templates, with compiled programs bloated by all their predecessor's dead-end coding contributions.

One field of engineering where sloppy programming doesn't work is in software for real-time communication devices and services. In real time systems, inefficient code affects system performance. Doing unnecessary calculations slows the system's ability to transport data adversely impacting the network's latency and throughput, i.e. data bandwidth. In professional radio communication systems, for example, propagation delays not only affect network performance metrics, but may result in complete and irrevocable loss of packets, payloads, and content. Not surprisingly, only the best programmers are capable of real time programming.

Smart contracts may be written in any number of computer languages, varying with both intended use and the targeted blockchain virtual machine host for contract execution. Programming languages used by various blockchain virtual machines and their blockchain users are listed here:
C++: EOS, HyperLedger Sawtooth, Iota, Wanchain, Solana, Stellar
C#: Neblio, NEO, Straitis
F#: NEO
Go: HyperLedger Fabric, Iota, Neblio, Stellar
Java: Ardor, Corda, HyperLedger Fabric & Sawtooth, Iota, Neblio, NEO, Smilo, Stellar
JavaScript: HyperLedger Sawtooth, Iota, Lisk, Neblio, Smilo, Stellar
Python: HyperLedger Sawtooth, Icon, Neblio, NEO, Smilo
Objective-C: Neblio

Many in the above list comprise general-purpose high level programming languages derived from C or Java. Other commonly used smart contract development include:
DAML: HyperLedger Sawtooth
Kotlin: Corda, NEO
Lidity: Smilo
LLL: Ethereum
Michelson: Tezos
PhP: Neblio
Plutus: Cardano
Ride: Waves
Ruby: Neblio
Rust: HyperLedger Sawtooth, Iota, Solana
Scala: Stellar
Scilla: Zilliqa
Serpent: Ethereum
Solidity: Aion, Binance, HECO, Enigma, Ethereum, Qtum
WebAssembly: EOS
Vyper: Ethereum
Yul: Ethereum

Of the foregoing, Solidity, a Java derivative language, controls the lion share of the smart contract programming market as it is the primary language employed on Ethereum EVM and Binance BSC. Rust appears to be a rapidly growing alternative used by both HyperLedger and Solana. Other blockchains claim to be agnostic to the languages employed in their smart contract execution. They include the Kimodo, Multichain, NEM, OpenChain, and Polkadot networks.

Efficient bug-free dApp development requires extensive experience to circumnavigate programming pitfalls. Accidental arithmetic errors, fixed integer decimal placement, hidden loops, undetected wait states, and incomplete transfers can result in catastrophic losses to investors, affecting the success of a project or the survival of a company. Given the plethora of programming languages, cross chain launches are especially complex and prone to execution risks. Poorly architected code, even if bug-free can still suffer from excessive gas fees or slow execution during high traffic events resulting in opportunity loss for investors.

One way to avoid badly implemented or buggy smart contracts is to employ an autonomous smart contract authoring system. But writing a dApp which authors bug-free smart contracts requires even greater skills than manually writing a smart contract. Only limited enclaves of skilled developers exist across the world able to master such challenges.

Executing dApps: A smart contract launched onto its host blockchain becomes immediately available for distribution and ready for use. As illustrated in FIG. 4, a function call 39a to the protocol 37a from a UI 36 or API retrieves the most current code 37c instance descended from the original parent block 37a via instance 37b and Merkel chain 39b and 39c. Accessed through a user interface (UI) 36 over a smartphone app or web browser, this up-to-date template (containing the BCVM's current world state) is downloaded 39d, modified to include the pending transaction (including any token exchange 35 and 50a from wallet 31) creating a new instance 37d. The updated contract 39e is then validated 38 and uploaded 39f back onto the chain 1 as smart contract 37e in block 2.. This latest uploaded instance is then used as the template for the next transaction, and so on.

In greater detail, the smart contract lineage is traced from its parent to its last entry on the blockchain, i.e. its most current instance, using a peer-validated Merkel tree (aka Merkel chain). Each instance of the smart contract is recorded on the blockchain sequentially using a time-stamped and peer-validated block. Like chain-native cryptocurrency, blockchain processing of smart contracts is executed by jurors to validate each new entry.

Dissimilar from cryptocurrency mining, however, miners validating smart contracts affirm the block's authenticity, but not its content. During validation, jurors do not (and often can not) interpret the meaning or functions contained within the smart contract. For reasons of security and privacy for example, portions of a smart contract can be hashed or encrypted and may not be decipherable by any trader except members within a defined pool. In order to ensure a contract is prepared properly, it is critical that only the most recent version of the smart contract is used as the starting point in writing a new contract.

The latest instance of a smart contract includes the most up-to-date contractual information, i.e. parametrics, needed to synthesize accurate executable code. Parametrics define conditional information that change over time needed to execute the smart contract, including date, time, interest rates, number and type of tokens in the pool, locking mechanisms, etc. For example, before a new contract can be written and recorded for swapping two tokens, the last smart contract must confirm enough tokens exist to execute the transaction. If a buyer tries to purchase more tokens than exist in the pool the contract cannot be executed. If a trader wants to execute a smart contract on the Ethereum blockchain using USN, the trader's wallet must contain sufficient ETH for the gas fee or the transaction cannot be processed.

Although program execution appears as a simple chronological sequence, to maximize throughput of the network smart contracts are constructed in hierarchical layers (subroutine calls) to avoid unnecessary consensus validations. FIG. 5 illustrates the hierarchical representation of a blockchain virtual machine stack. As depicted, a blockchain sits atop the Internet's TCP/IP protocol stack 40 as OSI Application Layer-7, separately comprising its own 4-layer blockchain stack 41 and BCVM sublayers 42a, 42b and 42c thereof.

Unlike the Internet's OSI layers, no standardized nomenclature for blockchains exist at this time. Regardless of terminology, the lowest layer in the blockchain stack is the infrastructure or network Layer 0 used to deliver network 44 and communication services to the blockchain 33. Blockchain Layer 0 (network layer 42a) provides services to blockchain Layer 1, the protocol or implementation layer 42b which manages data 26, the mining and storage of block content and chain-native cryptocurrency 34a; and system operations including the blockchain virtual machine (BCVM) 20 and consensus mechanisms 38. The Ethereum virtual machine (EVM) and Binance Smart Chain (BSC) are examples of blockchain Layer 1 implementations.

Blockchain Layer 1 in turn provides services to blockchain Layer 2, the transaction or application layer 42c used to execute dApps, smart contracts 37, and token 50b generation on the BCVM, providing scalability, and offloading tasks otherwise consuming system bandwidth on blockchain layer 1 bandwidth. Layer 2 implementations may include lightweight computing capability called “state channels” that does not require the same frequency of validation as blockchain Layer 1 processes. In this regard, blockchain Layer 2 is faster but less secure than Layer 1. Note that the term “application layer’ for layer 2 in the blockchain stack is not the same thing as Application Layer 7 in the Internet's TCP/IP communication protocol (the Internet supports all blockchain processing). Blockchain Layer 2 which relies on Layer 1 similarly provides services to blockchain Layer 3, the so-called Aggregation layer. The purpose of the aggregation layer is to bundle applications and services of Layer 2 for the convenience of users. For example despite representing different applications, staking (lending) and borrowing may, for customer convenience be bundled into a unified service sharing a single DeFi pool.

Notably, by processing tasks on a single blockchain layer or spreading them across multiple layers impacts performance, efficiency and security. These tradeoffs led Vitalik Buterin, the founder of Ethereum to coin the phrase “The Blockchain Trilemma” in recognition of a developer's challenge that implementing blockchain processing with fewer validation checks improves speed but invariably compromises decentralization and security, considering if a network hosting a smart contract is
Decentralized: creating a blockchain system that does use a central point of control
Scalable: the ability for a blockchain system support a large number of transactions
Secure: the ability of the blockchain system defend itself from attacks, bugs, and other unforeseen issues to maintain reliable operation.

In this regard, blockchain architecture, virtual machine implementation, and smart contract programming across multiple blockchain layers determine the performance, security, and reliability of any blockchain implemented smart contract. As such, consistent high-quality smart contract programming is necessary to avoid hacks and failures in decentralized finance transactions.

DeFi Pools: As illustrated in FIG. 6, hierarchical resources form the essential components of decentralized finance transactions in the crypto-economy. Based on the application layer of TCIP/IP, the Internet provides the network 44 for hosting perpetually-live permissionless blockchains 33 even though no dedicated memory is available as non-volatile storage. The blockchain in turn operates as the host platform for a high-uptime blockchain virtual machine (BCVM) 45 despite lacking any dedicated compute resources. The blockchain virtual machine forms the host platform for the execution of decentralized applications including dApps and smart contracts 36—transactional processes able to confidently enable financial transactions and commercial business despite lacking any central authority, bank, treasury, or centralized financial clearing house.

In one class of smart contract used to issue tokens (called a token launch), DeFi tokens 50 are generated and released into the wild in accordance with some defined schedule or set of conditions. Investors may acquire tokens as a direct purchase from the issuer, or alternatively by executing a token swap in a DeFi pool. In the context of a token launch today, a “DeFi pool” 46 is a smart contract facilitating the exchange of two digital assets—the newly generated DeFi token and a crypto cash equivalent (such as USDC, BUSD, WETH, etc.).

Unlike a DeFi trading pool (where either asset in the pool may be bought or sold at will), during a token launch the newly issued token can only be purchased, not sold. Such a DeFi pool may be referred to as a launch pad or an issuing pool. Two methods exist for an investor to acquire a newly minted token in private token presale—either by a direct purchase or through a DeFi pool. In a direct purchase after completing KYC/AML and pursuant to applicable regulatory statutes, a buyer purchases directly from the issuer. In DeFi, a prospective investor opens an autonomous transactional interface called a protocol and swaps a specified amount of crypto cash for the token being issued. In high-quality token offerings, demand generally exceeds supply.

As such, the maximum purchase quantity is unavoidably limited, i.e. allocated, on a per-person basis. Transactionally, a DeFi pool functions like a bank-less bank with “products” offering new issuances to venture capital, lending to stakers, borrowing for debtors, currency exchange (token swapping) for traders, and liquidity providing opportunities to market makers. Although a DeFi pool offers services much like a business entity, the pool itself is ethereal. There is no owner, operator, guarantor, or legal entity controlling its actions or defining its quiddity (its unique essence). In this regard, the operation of a DeFi pool is autonomous, and its existence, virtual. DeFi is diffuse in nature, with no physical presence within a single device, server, location, country, or legal domicile. If something goes wrong, there is no one to sue, and no one to blame but oneself.

Experientially, users interact with the DeFi pool using what appears to be a web interface. In reality, a DeFi user interface (UI) invokes an application program connecting their crypto wallet directly to the Ethereum, Binance, or other host blockchain. For the sake of security and privacy, no web interface should act as a data conduit in any crypto transaction. Web intermediaries cannot be trusted as they can easily capture, steal, and profiteer from access to a client's security credentials and private keys exchanged during a transaction, including the risk of wallet theft. Decentralized transactions thereby depend on trustless autonomous operation—not relying on anyone or anything to execute a transaction. Although theoretically, traders can write their own smart contracts to engage in transactions within a DeFi pool, in practice smart contracts are not written from scratch but instead are based on a contractual template called a protocol to define the specifics of a pool.

DeFi Protocols: Smart contracts play two major roles in supporting investors and entrepreneurs in today's rapidly evolving crypto-economy, specifically to facilitate
DeFi token trading for investors
DeFi token launches for issuers

Although both of these functions can be performed using a hard-coded smart contract, custom dApp development is slow and prone to errors. The alternative is to employ a transactional protocol for smart contract authoring. A transactional protocol, or simply a protocol, refers to software that autonomously creates smart contracts in accordance with user instructions. Theoretically, a smart contract authoring program for DeFi trading should be able to support a diversity of common DeFi transactions. In practice, most available protocols are designed to operate as single-function automatons, capable of performing only a solitary dedicated task, for example:
Swapping tokens in a DeFi pool for a single type of cryptocurrency, or
Staking a token in a DeFi pool for interest income, or
Borrowing from a DeFi pool against locked collateral, or
Providing liquidity to a DeFi pool as invested capital to earn fees

Separating investing and trading activities into separate protocols, while easier for developers, creates a more confusing user interface and a degrades user experience. Moreover, numerous inadequacies in the design and programming of present-day DeFi protocols adversely impact traders flexibility in participating in a DeFi pool. These inadequacies has an especially significant impact on companies or projects seeking to launch their own tokens. Important unaddressed issues limiting today's protocols include the following:
Inability to accept multi-currency payment (multiple crypto wraps and stablecoins)
Inability to control early selling and prevent rug pulls by managing locking and vesting
Inability to concurrently launch multi investor tranches with different vesting schedules
Inability to support swapping (capital investment) combined with staking (earning)
Inability to flexibly support new token launches
Inability to support transactions and launches concurrently on multiple networks
   Multi-currency Payments: Ideally investors using a protocol to acquire a token or partake in a new offering would like to pay in any form of crypto cash equivalent token that is convenient for them. In practice, however, as depicted in FIG. 7 each swapping pool 46a-46d comprises a single token-pair comprising the unique combination of one specific DeFi token and a particular cryptocurrency or crypto cash equivalent. For example for an enterprise to support sales of its fictious PRYS token 50c with payment of major crypto such as WETH, USDT, BUSD, and USDC it requires four separate pools 46a, 46b, 46c and 46d, respectively each requiring its own smart corresponding contract 37f, 37g, 37h, and 37i. The ability of programmer 52 to produce four separate instances of smart contracts error free is challenging and risky.

With all the issuing pools being separate the process of purchasing the token is also inconvenient for investor 30 where payment with WETH involves transaction 53a, payment with USDT involves a separate transaction 53b, and payment with USDC involves transaction 53c, all with their own gas fees, even though the investor is only purchasing a single token 50c. Real world examples include the challenge of purchasing a token such as Jasmy with USDC instead of WETH requires changing DeFi pools. Similarly a SHIB-USD [symbol] token pair cannot be mixed with a SHIB-BUSD pair, a SUSHI-WBTC pair cannot be pooled with a SUSHI-DAI pair, and so on. Aside from being terribly inconvenient for investors seeking to acquire tokens using a mix of cryptocurrencies and stablecoins, a rigid single token-pair DeFi pool forces issuers to allocate tokens to inactive or unpopular pools and tokens.

Multi-chain Token Trading: Most protocols are designed to operate on a single blockchain and are unable to support multiple networks, let alone cross-chain transactions. For example, a token offering on Ethereum employs EVM specific smart contracts not usable on the Binance's network or BSC virtual machine. This forces investors to trade exclusively on a single network even if transaction times degrade or gas fees become prohibitive.

Beneficially, multi-chain support as shown in FIG. 8 enables investors to optimize their trades and minimize gas fees and transactions costs. Unfortunately, most protocols are wholly incapable of supporting cross chain transactions or multi-chain token launches. Few developers today have the skill sets or acumen to author dApp protocols for multichain transactions or issuances. Instead programmer 52a launches 54a smart contract 37j on the Ethereum mainchain 33a. Successive trading (multi-swaps) involving smart contracts 37k, 37l, 37m, and 37n are costly on Ethereum because of high gas costs. Programmer 52b launching 54b smart contract 37o on the Binance smart chain 33b is able to support lower cost multi-swap transactions 37p and 37q but loses all interoperability with Ethereum. While Polkadot blockchain 33c offers low cost swapping via smart contracts 37r and 37s, programmer 52c launches 54c smart contract 37r completely independent of the Binance and Ethereum launches creating incompatibility risks.

Another missing features is the ability to intelligently minimize gas and transaction fees by employing minimum transaction algorithms in multi-swap trades.

Unlocked Tokens: A major issue plaguing DeFi investing today is the problem of early selling and insider rug-pulls. The early selling problem is intrinsic to a corrupt or badly-executed token launch by enterprise 51 where as shown in FIG. 9, early investors 55 with preferred pricing (e.g. VCs, exchanges, seed investors, and developers), are able to buy unlocked tokens 50z at deeply discounted prices compared to anticipated future market prices of the offering. If the purchase or presale tokens 50d is at discounted compared to IDO, TGE and exchange sales 50e and 50f only a small subset of buyers can sell their tokens 50z at lower prices and ruin the market before others can participate. Similarly any DEX hosting an upcoming listing also acquires token inventory at preferred prices using a volume price agreement. Later when decentralized exchanges launch the token for sale to its clients and it becomes tradable, e.g. during an initial DEX offering (IDO), the presale token holders secretly can execute a series of unauthorized sales undetectable by the DEX leading to a collapse of the token's price.

The problem with the unauthorized selling is there is no way to distinguish tokens approved for sale from those legally traded. Indistinguishability is a fundamental characteristic of a fungible currency, meaning once tokens are unlocked there is no way to restrict their trade. A rug pull is therefore the inevitable consequence of issuing unlocked tokens at the time they were first generated. One alternative means by which and issuer may prevent presale token holders from early selling is through delayed distribution—withholding the issuance of tokens to their buyers till a later date. This option although effective, is problematic in that few investors will agree to a purchase without some collateral protecting their invested capital until the token transaction is fulfilled.

One especially problematic exploit is the pump-and-dump (P&D) exploit shown in FIG. 10, where an investor accumulates 60c a large quantity of tradable tokens through presales and low volume buying at low prices 65a, then executes deceptive purchases 601 in small amounts to artificially inflate 65b the offering's market cap 64. After pumping the price 65c and attracting momentum traders as buyers, the investor sells a large quantity in a few trades 61a, 61b, and 61c resulting in a landslide 65d of selling driving the surviving token price 62 at an all time low.

NFT Specific Issues: While fungible tokens based on ERC-20 and BEP-20 standards share many features, benefits, and deficiencies as NFT based on the ubiquitous ERC-721 standard, one major difference is that most decentralized finance, although involving transactions on multiple chains, do not involve cross chain trading. Once a USDT token is generated for the BSC network it is not transported for use on the EVM network, but instead is converted in an exchange first In contrast, the market for NFTs varies by interest group (e.g. antique cars, comic books, sports, fine art, music, etc.). For whatever reason these groups often are traded in communities residing on different blockchains.

Most NFTs for example are first minted on the Ethereum then transferred to one or more different networks for marketing and community sales. In this sense NFT are not simply multi-chain assets but operate transactionally across multiple networks, i.e. NFTs involve cross-chain transactions. To accomplish this feat, NFTs employ wrapping (the same technology used to tokenize chain-native cryptocurrency such as ETH) to be compatible with their target blockchain. An example of this process is shown in FIG. 10A where NFTs are traded across three blockchains EVM 33a, BSC 33b and Polygon blockchain 33c.

As shown the original instance of NFT 88f created on EVM 33a was transferred to the BSC 33b network to become 88g because its prospective buyer was already trading on the Binance network. To transfer the NFT from Ethereum network to BSC, NFT 88f must first be wrapped so as to follow the protocols and code structure specific to the BSC smartchain. In other word the Ethereum based NFT is disguised as a Binance token by wrapping so it can operate in BSC 33b. After the sale, ownership of the NFT changes to create a new BSC token 88h. The process of wrapping and transferring a NFT from one blockchain to another is referred to as bridging.

Later however its owner wants to sell the same token to another buyer who happens to be on EVM 33a, the token is bridged to be compatible with EVM 33a not by reverting to its original form, but by wrapping token 88h with an Ethereum wrapper to generate BSC compatible NFT 88i comprising a wrap of a wrap. After selling the token to another Ethereum buyer, the new EVM token 88j is again wrapped and bridged to Polygon network 33c as NFT 88k, then sold to a new owner as 881, the rewrapped and bridged to another EVM buyer as token 88m. Token 88m therefore comprises a EVM wrap of a Polygon wrap of a EVM wrap of a BSC wrap of a EVM native NFT token, i.e. a wrap of a wrap of a wrap of a wrap, nested four layers deep. Although this is not a problem for traders who have no interest in accessing the NFT's true content, for collectors the situation is extremely problematic when unwrapping is needed.

Specifically as shown in FIG. 10B unwrapping a nested NFT can involve layer upon layer where NFT 88e is unwrapped by bridge 37v to reveal Polygon (XYZ) token 88d by paying for ETH as gas. NFT 88d is then unwrapped by smart contract 37u by paying MATIC as gas to reveal EVM token 88c, which in turn requires gas for smart contract 37t to reveals BSC based NFT token 88b, which finally can be unwrapped for BSC gas via contract 37 s to extract the original EVM native NFT token 88a to gain access to its metadata core 87. In other words, the buyer bears the full cost of the unwrapping, in many cases with no idea how much the process will costs or how many layers of nested wrapping there are.

### SUMMARY OF BACKGROUND

Considering the limited choices in DeFi protocols today and their intrinsic deficiencies, we are forced to concede that:
Today's DeFi protocols were created for dedicated token transactional trading in DeFi pools and DEXs, not for token launches.
Even best-in-class DeFi protocols lack the functions and features needed to support and manage a well-executed token launch.
Present DeFi protocols have no mechanism to prevent unauthorized selling or to protect IDO- and TGE-stage investors from unscrupulous private and presale holders liquidating their positions in rug pulls, pump-and-dump, and front-running^{[143][144]} exploits.
Standard protocols only capable of swapping designated token-pairs constrain prospective investors to specific DeFi pools, cryptocurrencies, and blockchains, reducing the attractiveness and availability of new offerings.
Most protocols operate on a single blockchain. Unproven protocols attempting cross-chain functionality are plagued by bugs, wait states, completion risks, and security vulnerabilities.
DeFi protocols rely on unsecure crypto wallets with untrustworthy identity verification mechanisms (two party authentication is inadequate).
No DeFi launch platform anticipates the life cycle management needs of a token offering.
NFT bridging is a costly and deceptive practice of selling assets containing hidden costs.
   What is needed is a new DeFi platform and protocol developed especially to meet the needs and address the concerns of projects, DAOs, and corporations launching their own tokens, and a better way to mint and trade tokens, especially NFTs.

### BRIEF SUMMARY OF INVENTION

A fully autonomous smart contract authoring system capable of concurrently generating multiple smart contracts from a single source file for a variety of blockchain networks from a single source file is disclosed, eliminating the risk of random programming errors and transactional losses. In one embodiment, the autonomous generator of decentralized applications employs a library of network protocols and token standards validated by third party experts to eliminate systematic errors during smart contract authoring. The autonomous authoring program includes smart contracts for launching new tokens and creating a variety of DeFi pools, each with unique price and vesting terms, along with companion dApps for trading, a UIUX interface, an automatic market maker for maximizing pool liquidity, decentralized oracle for real time data needed to support rational trading practices.

In another embodiment, the autonomous smart contract authoring program generates multi-crypto pools able to support trading and remuneration using a variety of cryptocurrency wraps such as WETH and a number of stable coins such as USDT and BUSD. The disclosed AMM is furthermore capable of supporting balancing of all assets contained in any multi-crypto trading pool

In another embodiment, the autonomous software generates a pool comprising the token to be launched and a collateralized transaction kTx token acting as its proxy, whereby the kTx token distributed to investors is collateralized by an equal amount or value of enterprise tokens generated at its token generation event (TGE). The kTx tokens can later be used as proof of purchase and for redemption to claim the issued enterprise token in accordance with a smart contract defined autonomously executed vesting schedule. In another embodiment, the vesting schedule, price per token, and total supply of the issued token is arranged into distinct tranches as defined by the token issuer.

In another embodiment the kTx tokens may be hypothecated before its underlying collateral asset is vested and unlocked, either through a combined swapping and staking, combined swapping then staking, or by swapping or staking is collateralized token exchange (a KDEX) as a derivative market.

In another embodiment the autonomous smart contract authoring program is able to generate both fungible and non-fungible tokens, i.e. FTs and NFTs based on its input file and metadata.

In yet another embodiment the dApp is able to teleport NFTs cross chain without the need or hidden cost of nested wrapping, thereby facilitating a speedy cost efficient vehicle for cross chain trading.

### BRIEF DESCRIPTION OF THE DRAWINGS

FIG. 1 illustrates a blockchain hash chain and Merkel tree used for validating new blocks.

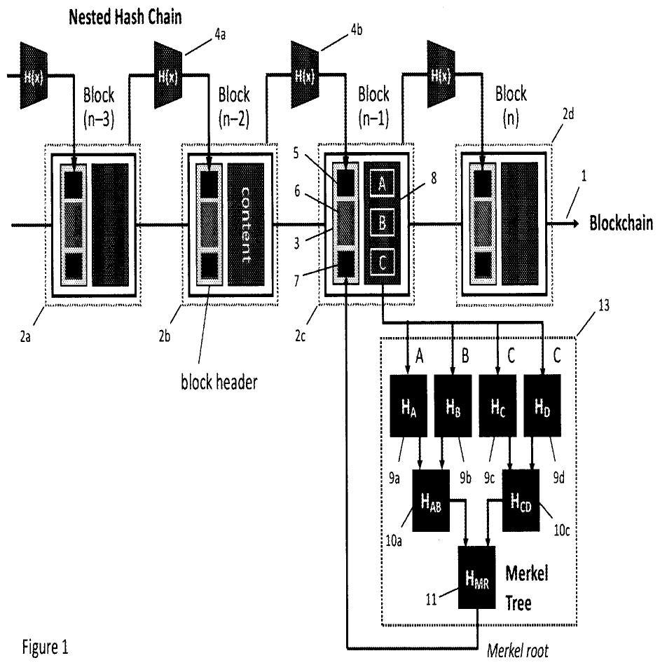

FIG. 2 illustrates blockchain virtual machine implementation on Ethereum.

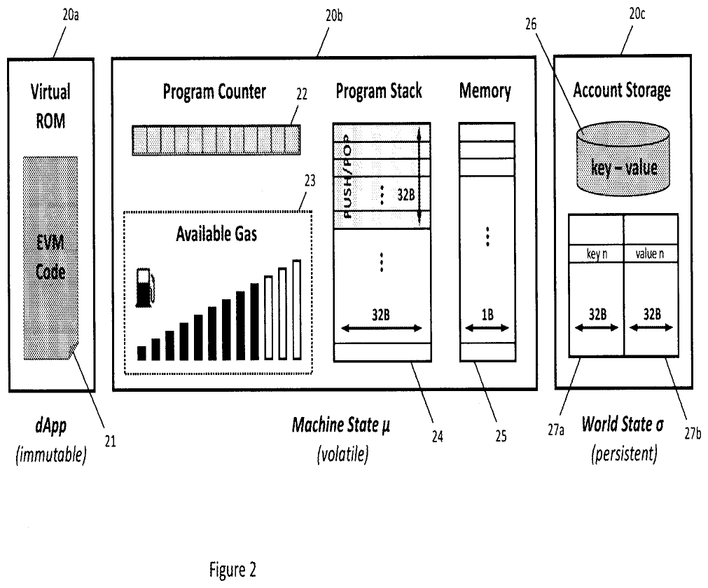

FIG. 3 illustrates the process of wrapping ETH cryptocurrency to create the token WETH.

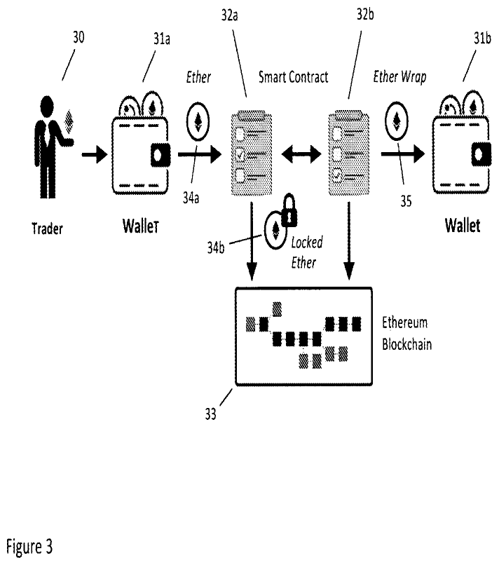

FIG. 4 illustrates the process of calling a smart contract, amending it, and registering the changes as a validated block.

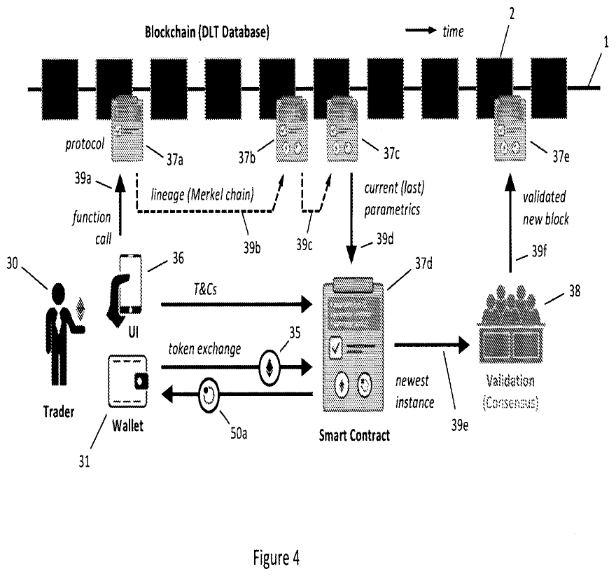

FIG. 5 illustrates the relationship among the blockchain layers and sublayer to the OSI network (TCP/IP) communications network stack.

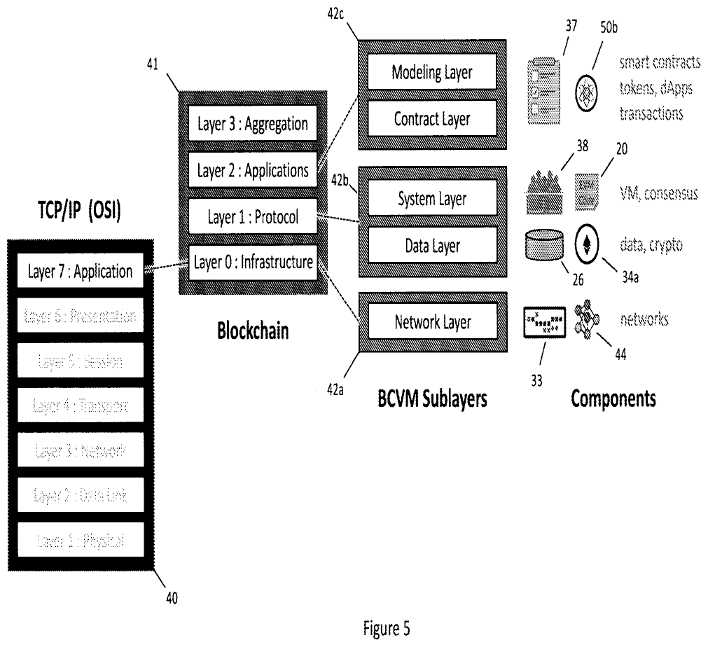

FIG. 6 hierarchically illustrates the resources needed to execute smart contracts, generate crypto tokens, and host DeFi pools.

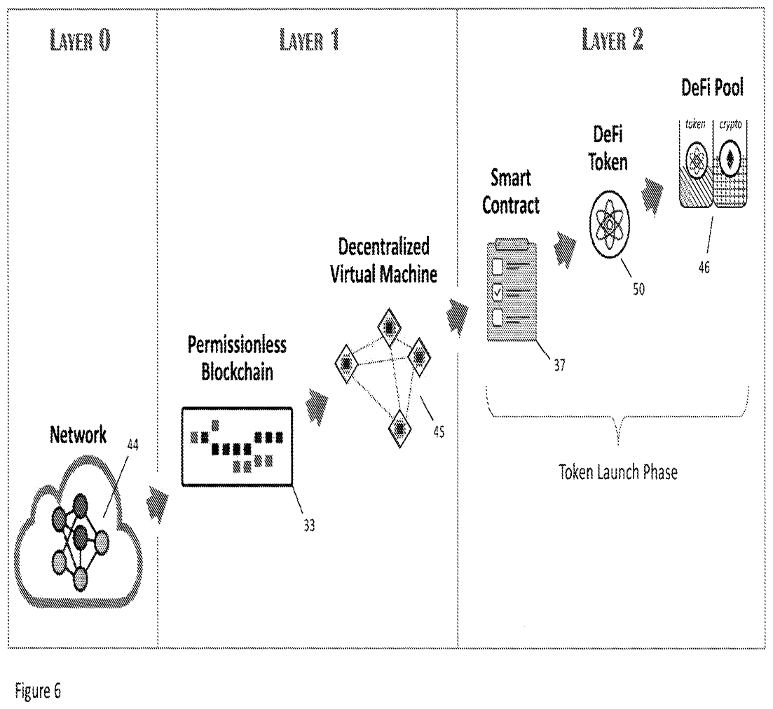

FIG. 7 illustrates distinct smart contracts must be used to issue tokens on different blockchain networks.

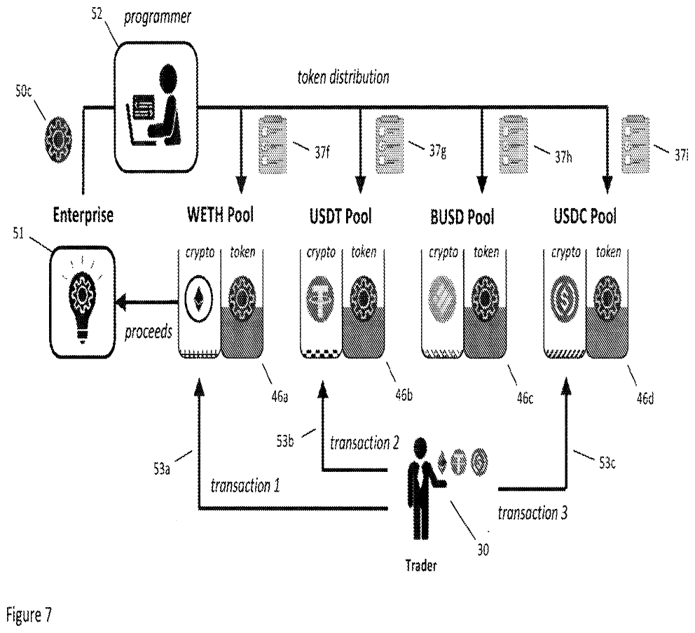

FIG. 8 illustrates multichain token transactions.

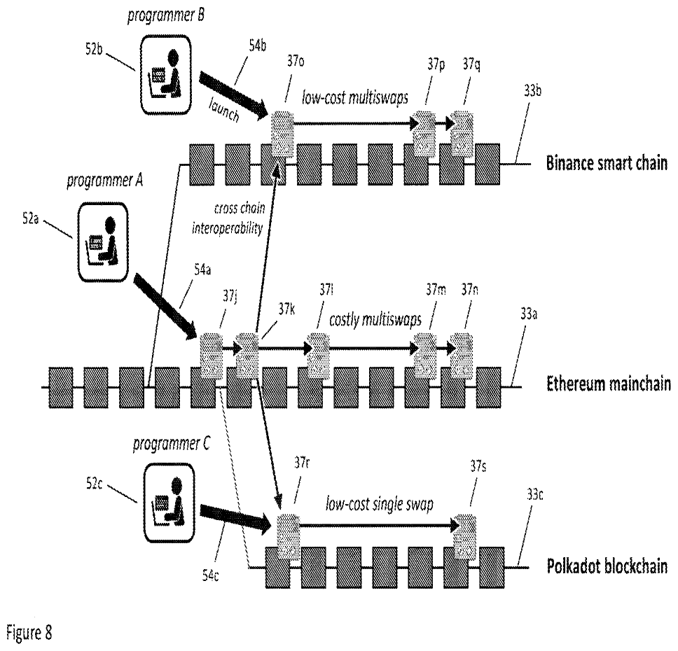

FIG. 9A illustrates the process of an enterprise issuing tokens to investors and the risk of unauthorized selling.

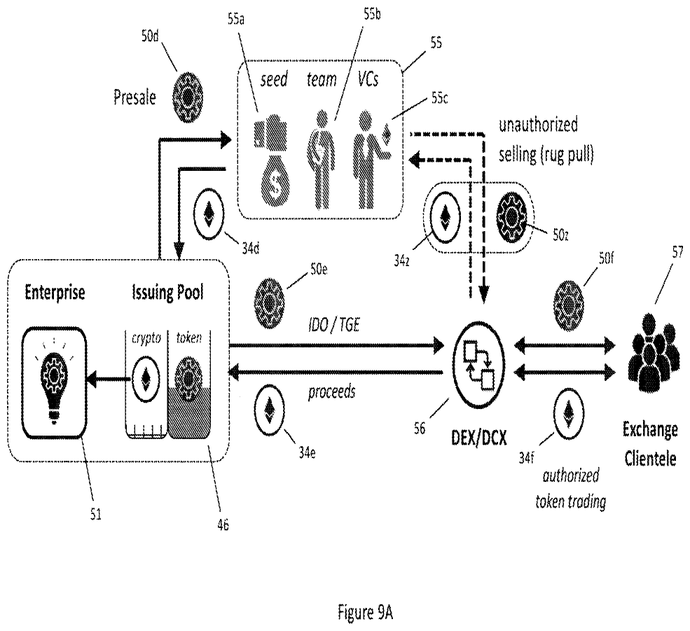

FIG. 9B illustrates token trading in a pump-and-dump exploit.

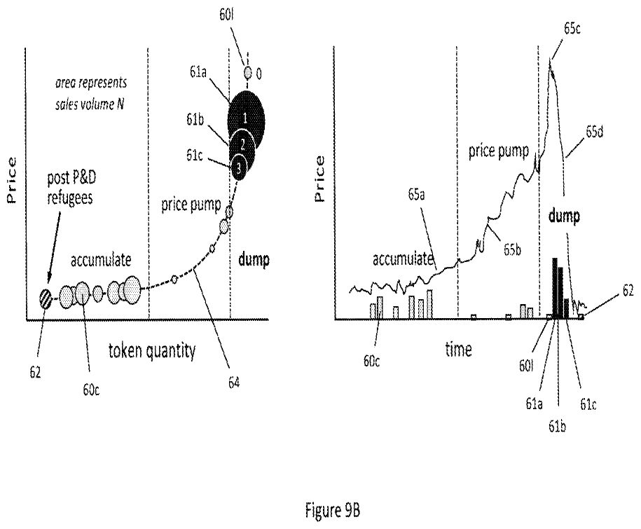

FIG. 10A illustrates the process of NFT bridging.

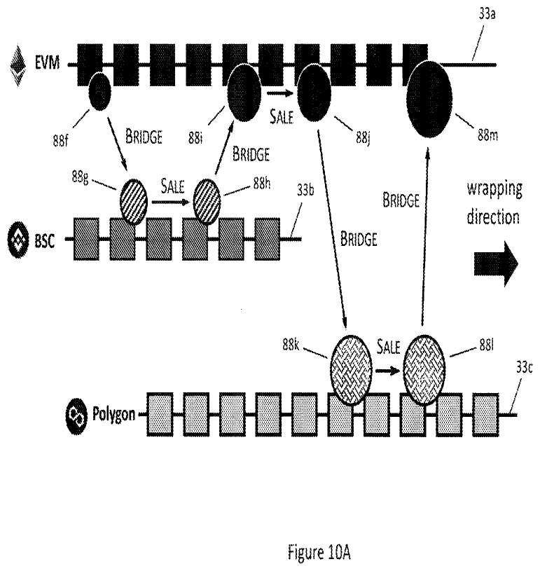

FIG. 10B illustrates the problem of nested NFTs arising from repeated bridging.

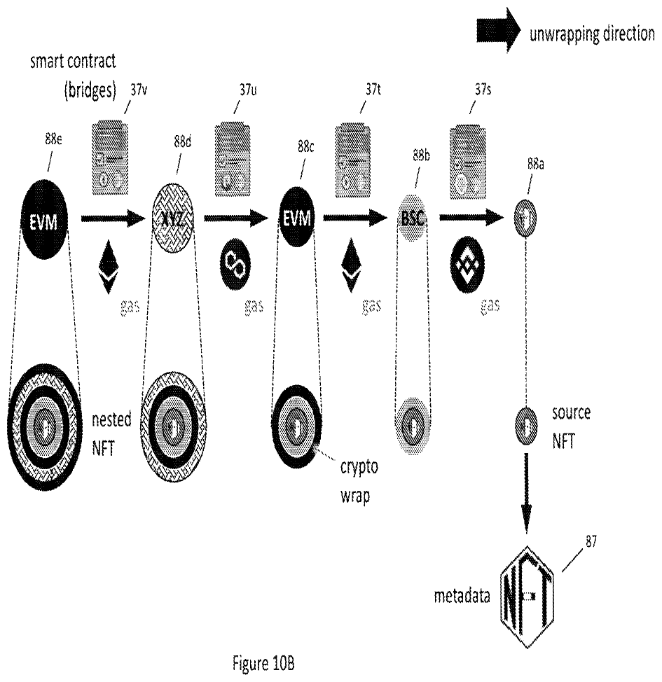

FIG. 11 compares autonomous smart contract authoring to hand coded programming.

FIG. 12 illustrates the role of the LaunchBot in token generation and distribution.

FIG. 13 illustrates various decentralized applications comprising the disclosed Launchpad ecosphere for DeFi.

FIG. 14 illustrates the method for autonomous contemporaneous authoring and execution of multiple smart contracts on separate blockchain networks.

FIG. 15 illustrates a concurrent token launch on multiple blockchains with differing token vesting and prices.

FIG. 16 illustrates the role of a decentralized oracle in assessing asset spot pricing during a transaction.

FIG. 17 illustrates LaunchBot dApp executed autonomous smart contract authoring for a multi-crypto DeFi pool.

FIG. 18 illustrates a SwapBot dApp executed autonomous smart contract execution for trading in a multi-crypto DeFi pool.

FIG. 19 illustrates an exemplary user interface (UI) for SwapBot autonomous token trading.

FIG. 20A illustrates the initial steps required for procuring tokens through the SwapBot interface.

FIG. 20B illustrates the final steps required for procuring tokens through the SwapBot interface.

FIG. 21 provides an exemplary comparison of the operation of a token trading pool to that of a token issuing pool.

FIG. 22 illustrates the role of decentralized oracle in maintaining DeFi pool liquidity via an automatic market maker (AMM) dApp.

FIG. 23 illustrates AMM operational guidelines in a multi-crypto DeFi pool.

FIG. 24 illustrates the process of issuing unlocked tokens at TGE.

FIG. 25 illustrates an exemplary blend of tokens issued in a token generation event (TGE).

FIG. 26 illustrates locked, vested, and unlocked token distribution to various sales channels.

FIG. 27 illustrates exemplary tokenomics of a token offering.

FIG. 28 represents LaunchBot token distribution using push vesting airdrops.

FIG. 29 illustrates the creation of a collateralized transaction token (kTx) DeFi pool.

FIG. 30 illustrates the implementation of a kTx swap pool and token distribution therefrom.

FIG. 31 illustrates a token offering pool may be emulated in parts comprising a collateralized kTx pool and a kTx swap pool.

FIG. 32 illustrates kTx token distribution through various channels.

FIG. 33 illustrates the process of issuing kTx tokens at TGE.

FIG. 34 illustrates a comparison between an unlocked token launch and one comprising collateralized locked (kTx) tokens.

FIG. 35 illustrates various stages in deploying a kTx pool comprising inception (launch), kTx sales, and kTx redemption.

FIG. 36 illustrates a three asset representation of the various stages in deploying a kTx pool comprising inception (launch), kTx sales, and kTx redemption.

FIG. 37 Illustrates an exemplary stepwise token vesting followed by kTx redemption.

FIG. 38 illustrates a multi asset representation of a multi-crypto pool with kTx tokens.

FIG. 39 illustrates the use of kTx tokens in swap then stake investing.

FIG. 40 illustrates the use of kTx tokens in swap and stake investing.

FIG. 41 illustrates kTx derivatives trading involving swapping or staking.

FIG. 42 illustrates the autonomous generation and distribution of a NFT portfolio.

FIG. 43 illustrates the disclosed method of NFT teleportation.

### DESCRIPTION OF THE INVENTION

This disclosure describes innovative advancements in the reliable processing of blockchain hosted data and decentralized applications (dApps) and their application for
Autonomous Smart Contract Authoring Ecosphere
Multi-chain smart contract authoring and transactions
Multi-currency DeFi pool transactions
Decentralized data oracle for rational asset trading
Collateralized transactional (proxy) tokens issuance and vesting
Cross-chain teleportation of digital assets

Autonomous Smart Contract Authoring Ecosphere: As described previously, the rapid growth of decentralized finance (DeFi), the generation and distribution of fungible and non fungible tokens, and the issuance of autonomous permissionless DeFi pools for trading, investing, asset swapping, lending (staking), borrowing, and liquidity providing (market making) has prompted the emergence of a burgeoning industry in creating and launching decentralized applications (dApps) for the processing digital cryptographic assets using smart contracts executed on blockchain virtual machines.

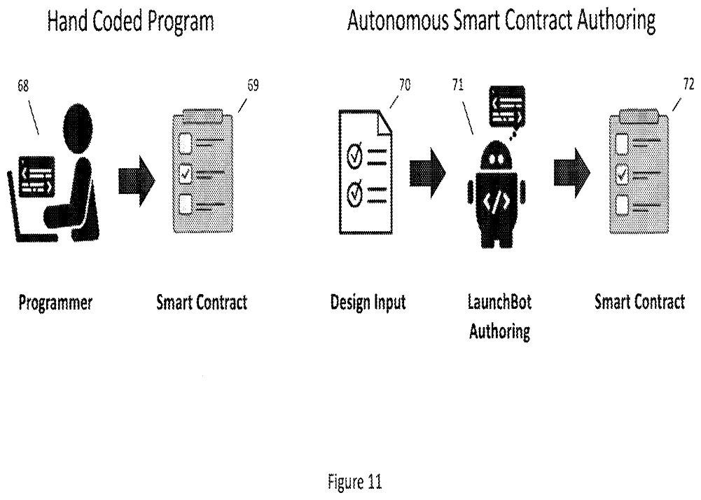

As illustrated in FIG. 11, many smart contracts 69 are created by hand coding of software by software programmers 68. This trend has resulted in a variety of problems resulting in theft or loss of billions of dollars of assets and invested capital. The cause of these unfortunate outcome are many, some based on ignorance or negligence, others due to intentional malfeasance and criminality or susceptibility to vulnerabilities, hacking, or market manipulation. Aside from simple cryptographic key and wallet theft, reasons for smart contract failures include the following:
Many programmers are unfamiliar with the software (such as Solidity) used to implement decentralized applications and smart contracts.
Many programmers have no experience in writing program code to run on blockchain virtual machines (BCVM). Unlike today's high performance notebooks, desktops, and smartphones, in order to ensure decentralization cloud of network nodes is limited by its low performance connected devices. As such the performance of BCTMs is limited to extremely low throughputs in the hundreds of thousands of instructions per second, the speed of computing in the 1960s. Complex programs can produce extremely slow response, indefinite wait states, infinite loops, or crashes in the middle of a transaction, possibly resulting in an irrevocable loss of assets involved in a transaction
Most programmers are used to floating point mathematics and unfamiliar with fixed integer arithmetic required by dApp software.
Popular token protocols such as ERC-20 have instructions such as “transfer” that are “no longer recommended” as they may be unable to detect a transfer was incomplete and irrevocably transfer the asset into nothingness.
Hand coded programs have undetectable random errors producing a plethora of malfunctions or worse. The cost of using a third party to certify the integrity of every hand coded program is enormous.
Each smart contract has peculiar vulnerabilities unique to the blockchain it is launched on and the token-pair it transacts. Launching a new token able to trade with multiple currencies requires a new smart contract for each token pair. For example, launching the fictitious enterprise ‘PRYS’ swappable for Ether and the four common stablecoins requires five smart contracts per network—one for each token pair, i.e. ETH-PRYS, USDT-PRYS, USDC-PRYS, BUSD-PRYS, and DAI-USD. If the token is launched on three chains, the number of hand-coded smart contracts will triple, each susceptible to their own random errors.
Criminals and unscrupulous programmers can build in back doors for hacking and embed intrinsic vulnerabilities to various “legal” exploits such as front-running (the trading version of line jumping in an exchange live order book)

The obvious solution to the problem is to automatically generate the software, but no such standardized program generation code exists, particularly since each blockchain has the singular purpose of attracting the majority of clients onto their platform and to discourage use on other networks. For example the company Binance which host the Binance smartchain virtual machine using its own proprietary BEP-20 token standard has no interest making it easy for clients to use the networks offered by Polygon, Solana, or Cardano.

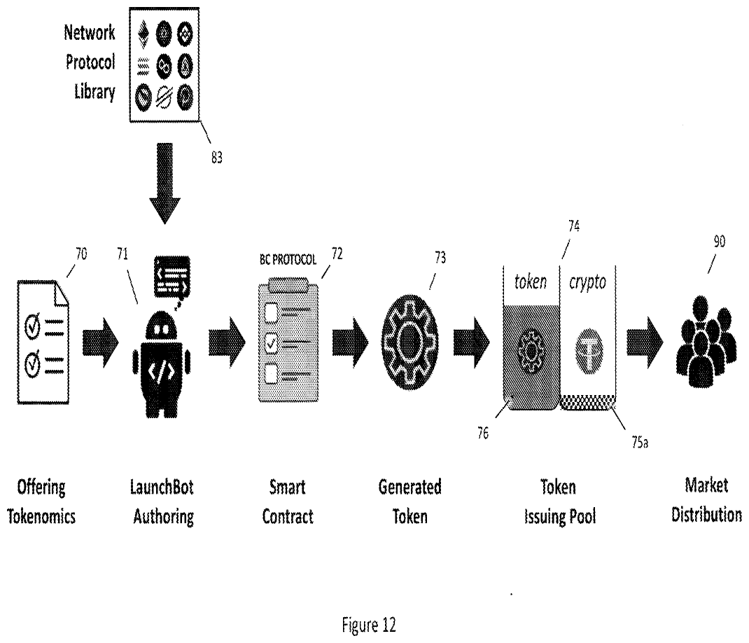

As such, this patent describes a pioneering autonomous smart contract authoring program for launching new dApps and tokens referred to herein as a LaunchBot authoring program. As depicted in FIG. 12, LaunchBot 71 automatically and autonomously converts input file 70 into smart contract 72, where smart contract 72 is a blockchain specific decentralized application. In other words, the LaunchBot 71 authoring program creates smart contract 72 computer code in accordance with its input file 70 to generate token 70 and to create a method to distribute the newly launched token 70 to the market 90 by generating token issuing pool 74 able to exchange a quantity 76 of fungible tokens for other tokens 75a comprising stablecoins) e.g. USDT, USDC, etc.) or wraps of cryptocurrency (such as WETH).

In order to perform error-free blockchain smart contract authoring, LaunchBot 71 must know the specifics of the offering—the offer's tokenomics as specified by input file 70 and also the unique requirements of the blockchain networks on which the toke is to be made available for trading. The network specific requirements including the software language employed (Solidity, Vyper, Simplicity, Vama, Obsidian, etc.) and various fungible token standards (ERC-20, BEP-20 etc.) or non-fungible token standards (ERC-721) are precisely specified in a network protocol library 83. Specific to a particular blockchain protocol, each executable smart contract 72 may also ne referred to as a protocol because it embeds instructions and code interpreted by a specific blockchain virtual machine (BCVM).

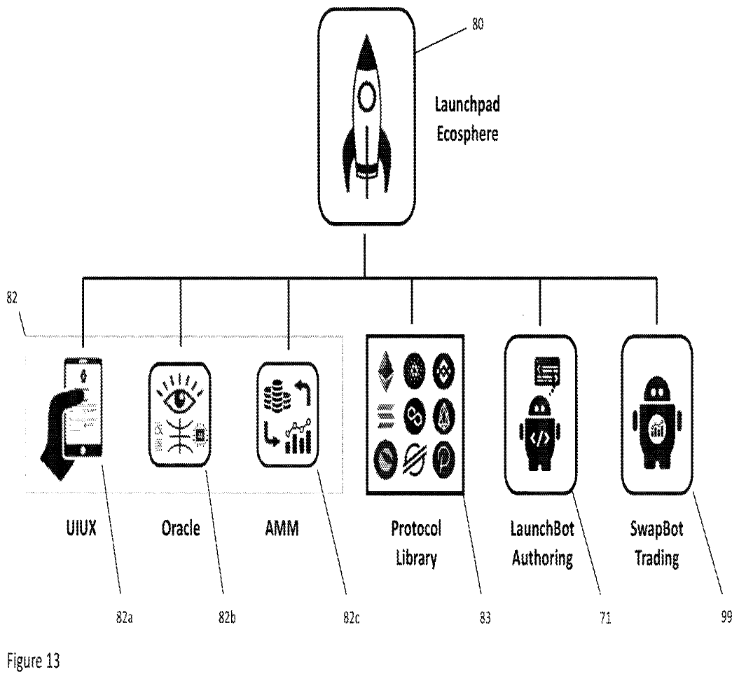

Although LaunchBot 71 program is able to author smart contracts from input file 70 made in accordance with network protocol library 83, executing the autonomously generated smart contract 72 requires interaction with additional decentralized applications supporting its operation. These utilities, while not able to conduct transactions on their own, gather and provide important information to smart contract 72 during its operation. As shown in FIG. 13 they include:
A intuitive user interface designed to provide immediate feedback to a trader (good user experience) in response to entering data (for example to instantly recalculate the number of tokens to be purchased once a purchase code is entered). Since blockchain transactions are irrevocable, UIUX 82a is important to prevent accidental or unintended trades or financial losses resulting from operator error. UIUX 82a, is interoperable with smart contract 72 as its interface. UIUX 82a may be embedded within smart contract 72 or alternatively operate independently as a decentralized application with a secure application processor interface (API) to all instances of smart contract 72 on any blockchain.
A decentralized Oracle 82b to collect on-chain and market data and pricing from centralized exchanges (CEXs) and decentralized exchanges (DEXs) and to transfer the information to UIUX 82a for display and to calculate swap ratios when trading one token for another, or valuing volatile wrapped cryptocurrency at market spot prices. Because multiple instances of smart contract 72 can be launched on differing blockchain networks, Oracle 82b must support multi-chain monitoring with cross-chain interoperability.
An automatic market maker decentralized application, AMM 82c used by liquidity providers investing in DeFi pools to dynamically level the pool asset values in the pool, maximizing liquidity and prevent external arbitrage losses, especially in the inventive multi-crypto trading pools with multi-chain interoperability as disclosed hereon.
A trading bot decentralized application SwapBot 99 used to interface UIUX 82a to any and all instances of smart contract 72 hosted on various blockchain networks.

As disclosed herein, the combination of the integrated suite of interoperable decentralized applications comprising LaunchBot 71 authoring dApp, Protocol Library 83, UIUX dApp 82a, Oracle 82b dApp, AMM 82c dApp, and SwapBot 99 trading dApp, facilitate a turn-key solution, a Launchpad Ecosphere 80, to token launches, token trading, blockchain processing, and token life-cycle management (including vesting, distribution, staking, etc.).

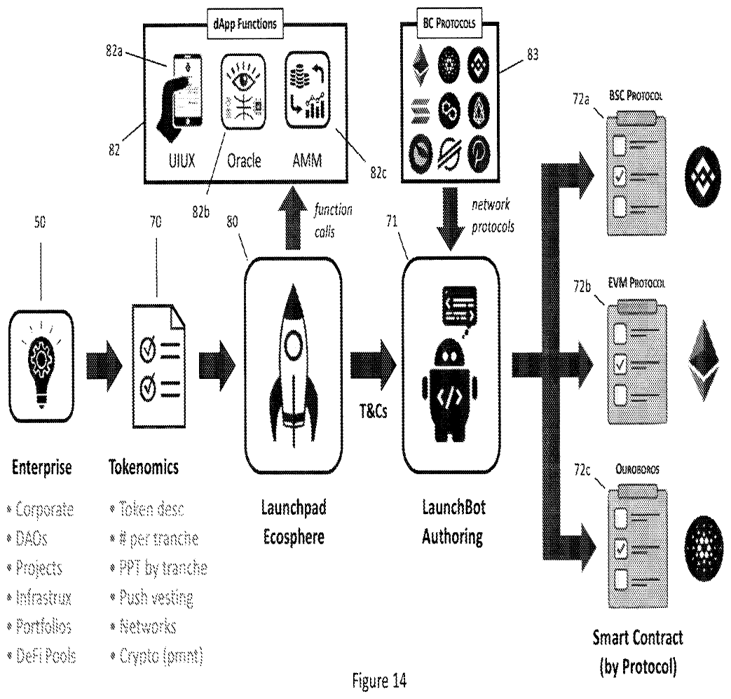

The process of a multi-chain token launch using the disclosed Launchpad ecosphere 80 is illustrated in the flow chart of FIG. 14. As shown, using Launchpad ecosphere 80 Enterprise 50 prescribes the tokenomics 70 of a prospective offering. In response Launchpad ecosphere 80 passes terms and conditions of tokenomics 70 to LaunchBot 71 authoring program which when combined with requisite details of blockchain networks contained in Protocol Library 83 autonomously and concurrently generates multiple blockchain-specific smart contracts 72a, 72b, and 72c, in this example representing executable dApp code for three BCVMs, namely the Binance smartchain (BSC), Ethereum virtual machine (EVM), and Solana's Ouroborus. As part of interoperable tool suite, Launchpad ecosphere 80 generated smart contracts 72a, 72b, and 72c include APIs, function calls, or other links to various dApp functions 82 including UIUX 82a, Oracle 82b, and AMM 82c.

In the context of clients of autonomously generated smart contracts, the term enterprise 50 is used in the broad definition which e.g. according to the Cambridge dictionary includes “an organization, esp. a business, or a difficult and important plan, esp. one that will earn money” (which covers pretty much anyone or a group of people seeking a common goal). In that regard, the list of enterprises wishing to offer tokens today, both fungible and NFTs, is an ever growing list including corporations, institutions, sports teams and franchises, VC funded projects, consortiums, infrastructure for blockchain commerce, investment and real estate portfolios, any group of investors wishing to sponsor DeFi pools as liquidity providers and market makers, universities, honorariums, estates and home offices, portfolio and fund managers, financial service providers, crypto-backed credit card companies, and more.

Unlike conventional business commerce, token issuers may comprise projects and DeFi pools having no legal standing, registration, or physical domicile such as decentralized autonomous organizations (DAOs). Musical and video artists; painters, sculptures, and graphical artists; curated art museums and auctions; architectural and interior design, online and play-to-earn gaming (P2E) and other art-business cross-over industries, like sports and sports gambling are uniquely suited as they include hybrid offers of fungible token offerings plus NFT collectables.

Other markets for fungible-NFT linked offerings include the use of fungible (ERC-20) token staking (locked deposits) not for interest income but to confer privileged access to upcoming and VIP only events and offerings, e.g. first-come-first-serve auctions, concert seats, meet-and-greets, exhibition access, upgrades, and more. Another developing application for NFT launches involves proof-of-authenticity important in the fine art and collectables market for paintings, luxury watches, baseball cards, vintage comic books and manga, rare tickets, books and more.

Tokenomics 70 may apply to both fungible and NFT offerings. The tokenomic term sheet for fungible token offerings includes the total token offering; the blockchain networks hosting the token; the vesting mechanism such as push vesting or proxy kTx redemption (described later); the vesting schedule and price per token by tranche; the method of payment (i.e. which crypto can be swapped on a specific network) including the option for multi-crypto pools; tradable versus locked tokens at TGE; as well as the IDOs, DEXs, CEXs, and DeFi pools supported in the offering. In contrast, non-fungible token (NFT) offering generated by Launchpad ecosphere 80 include owner and royalty considerations (to be embedded into issued ERC-721 tokens), vesting, and supported marketplaces. Regardless of whether an offering is a fungible or non-fungible token, or a mix thereof, the tokenomic model defined by tokenomics 70 long with the selected blockchains for the offering determine the smart contracts produced.

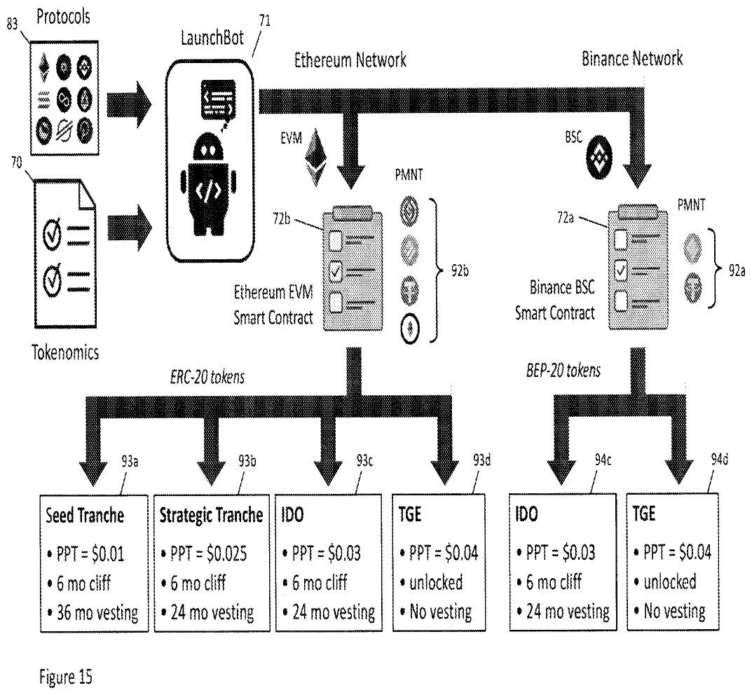

The interdependence of a multi-chain enterprise token offering authored by LaunchBot 71 based on tokenomics 70 and the applicable blockchain and token protocols from protocol library 83. As shown by example in FIG. 15, two smart contracts 72a and 72b autonomously authored based on the input data to LaunchBot 71 are not symmetric, bit differ by the target blockchain. For example, smart contract 72a created for the Binance BSC network (and the BSC virtual machine) employ only BEP-20 tokens distributed in limited quantity through Initial Decentralized Exchange (IDO) offering 94c at a price-per-token at $0.03 and with 6-month cliff vesting following by monthly vesting for 24 months (4.2% unlocked monthly), and token generation event (TGE) offering 94d at a price-per-token at $0.04 and with no locking, i.e. immediately tradable. Execution of BSC smart contract 72a is only able to accept payment 92a using Binance BNB and BEP-20 USDT crypto.

The same offering generated by LaunchBot 71 via smart contract 72b created for the Ethereum network (and the EVM virtual machine) employs ERC-20 tokens distributed through multiple channels including Seed Tranche 93a, Strategic Tranche 93b, IDO 93c and TGE 93d at the price-per-token (PPT) of $0.01, $0.025, $0.025, and $0.04 respectively. Although the Seed, Strategic, and IDO tranches share a common 6 month cliff vesting, the Seed tranche 93a has a 36-month vesting (2.8% per moth) while the Strategic and IDO tranches 93b and 93c each offer a more preferable 24 month vesting schedule (4.2% per month) as compensation for their higher selling price. The tokens offered by smart contract 72b on the EVM for the public offering TGE 93d are immediately unlocked with no vesting schedule. Unlike BSC smart contract 72a, execution of EVM smart contract is able to accept payment 92b using a wide range of ERC-20 tokens including (by example), WETH (Ether wrap), USDT, BUSD, and USDC. The list of tokens is exemplary and not intended to be limiting.

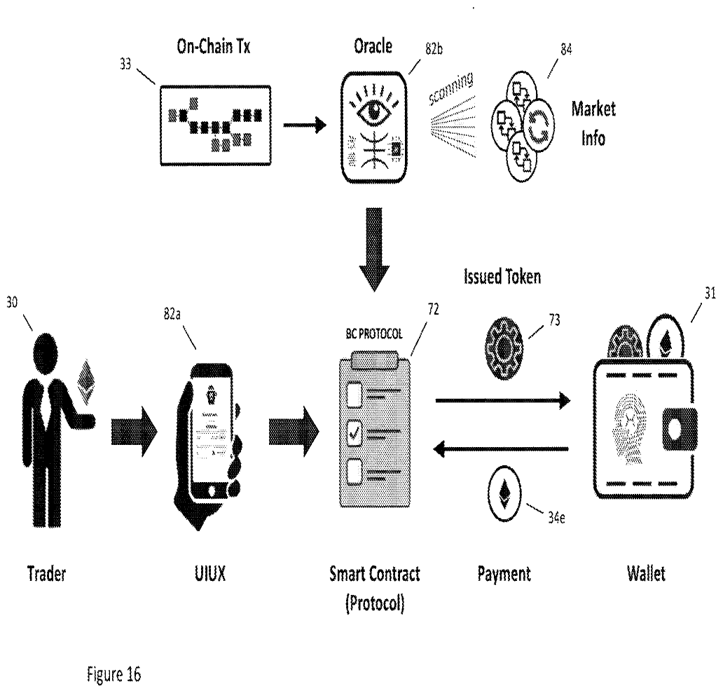

Another feature of Launchpad ecosphere 80 is the important role of its Oracle 82b. As illustrated in FIG. 16, for any trade involving the swapping of a digital asset having a volatile market price, the value of such as asset must be ascertained using its “spot” value in the market at the moment of the trade. The role of Oracle 82b is to determine the real-time value of an asset in centralized exchanges and other markets 84 and to confirm the most recent trades, i.e. on-chain transactions 33 registered on the token's host blockchain. The current price of a volatile asset, e.g. cryptocurrency wrap 34a, determines its exchange rate for enterprise tokens 73 swapped between investor wallet 31 and smart contract 72 in accordance with instructions from investor 30 entered via UIUX 82a.

Multi-crypto DeFi Pools: In conventional token offerings, remuneration for acquiring a token asset during swapping is facilitated through multiple DeFi pools comprising separate token-pairs, one for each form of payment. The practice of subdividing swap pools for a new token issuance into separate smart contracts is unwise and limiting as it reduces trading liquidity and greatly complicates trading transactions, adversely impacting a trader's user experience. If a trader selects a DeFi pool for its plentiful supply of enterprise tokens but with the wrong form of crypto as payment, they will be unable to complete the transaction.

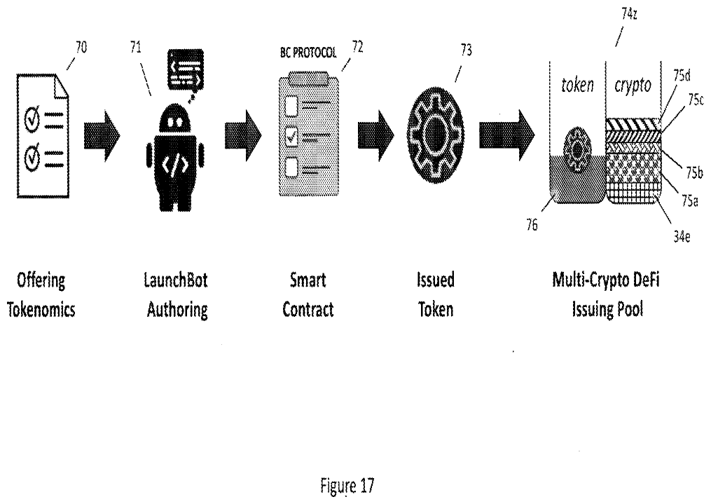

The solution to such a quandary is the inventive feature described herein as a multi-crypto DeFi pool. Such a pool as depicted in FIG. 17 comprises pool 74z containing the aggregate value 76 of issued token 73 and a heterogenous complement of swappable assets, referred to herein as “crypto” comprising the aggregated value assets 34e, 75a, 75b, 75c, and 75d. In an issuing pool as more tokens 73 are sold, the total value 76 of the remaining tokens likely diminishes even if the price-per-token increases. Conversely the value of the total of crypto assets increase. The creation of the multi-crypto pool is embedded into smart contract 72 as the dApp generated by LaunchBot 71 made in accordance with input 70 defining the offer's tokenomics. Once the issuing pool is depleted of newly issued enterprise tokens, a liquidity provider can infuse capital to balance the crypto value and token value, generally by selling the asset of greater value (crypto z), buying more of the assets of lesser cumulative value (token 73), or both.

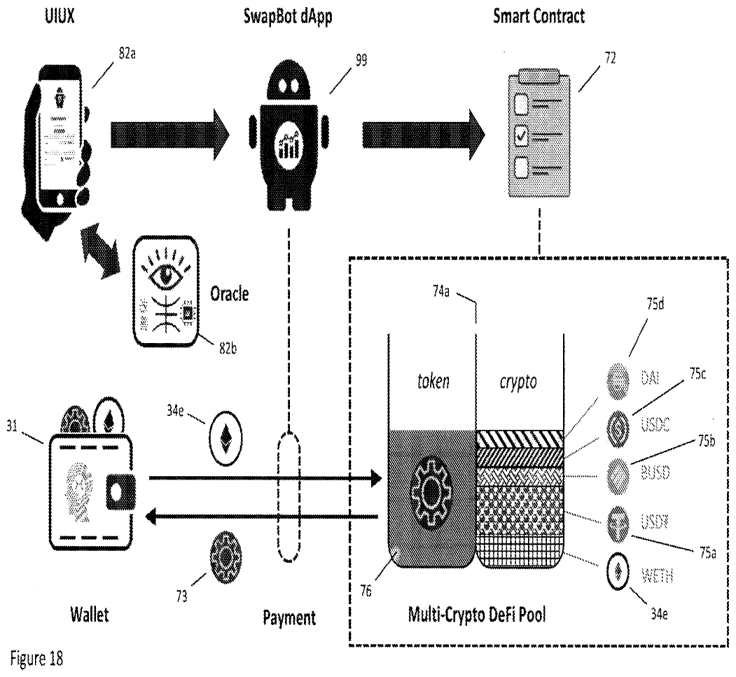

Pool 74a once balanced is shown in FIG. 18 where the value of the crypto equals the market trading value 76 of enterprise token 73, whereby

Value (PRYS)=(# of PRYS)·PPT(PRYS)

Value (crypto)=(# of WETH)·PPT(ETH)+$1·(# of USDT+# of USDC+# of BUSD+# of Dai)

for cryptocurrency wrap WETH of value 34a, and stablecoins comprising USDT of value 75a, BUSD of value 75b, USDC of value 75c, and Dai of value 75d and where assuming for stablecoins PPT (USDT)≈PPT (USDC)≈PPT (BUSD) PPT (Dai)≈$1.0, the DeFi pool is balanced at

Value (PRYS)=Value (crypto)

and its total market cap is given by the total sum of its assets or

Value (pool 74a)=Value (PRYS)+Value (crypto)=2Value (PRYS)=2Value (crypto)

In operation, purchases and sales (swaps) of pool assets are managed by a software based trading bot dApp referred to herein as SwapBot 99 managing transfers to and from wallet 31 in accordance with the trade instructions received via UIUX 82a and recorded by smart contract 72. In the event that a traded asset has a time varying price per token, i.e. either enterprise token 73 or a cryptocurrency wrap (such as WETH 34e), the spot value of the assets are calculated based on real-time market data gather by Oracle 82b. Until enterprise token 73 lists on a private DEX or public exchange, its price-per-token is assumed to remain at its last traded price.

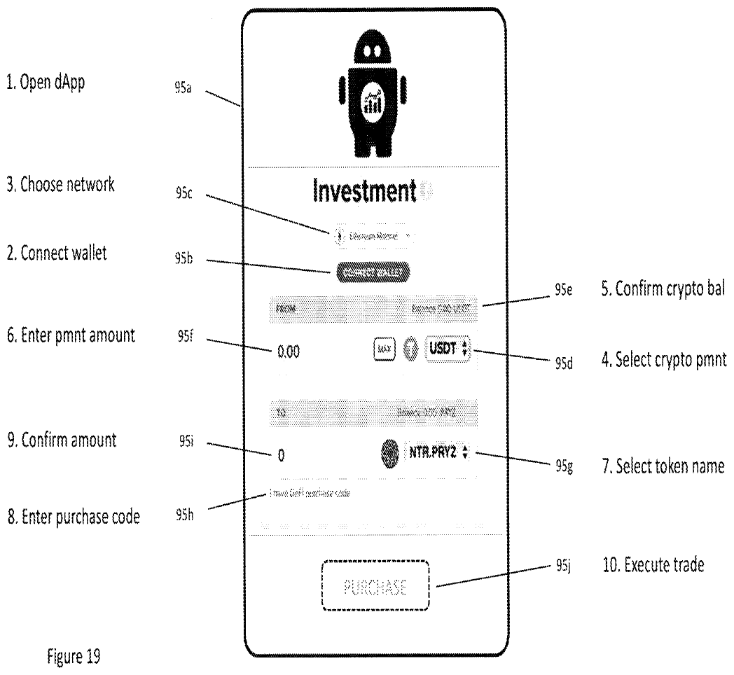

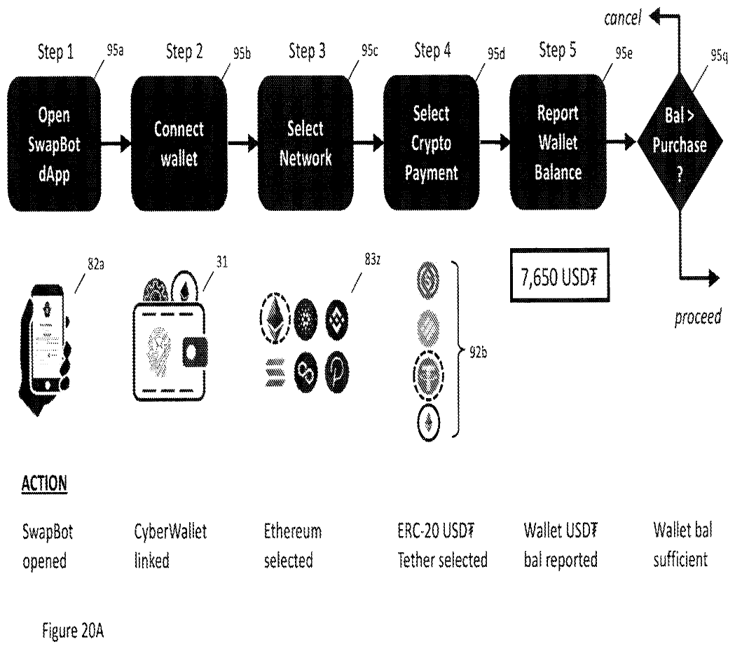

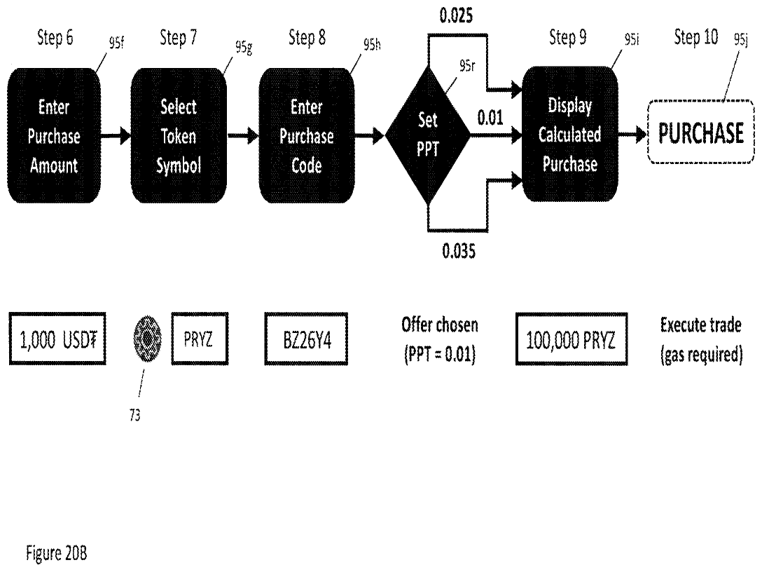

Despite any complexity in implementing smart contract 72 managing multi-crypto pool 74a, investor see the pool as a convenient means to obtain a newly issued enterprise token 73 using a variety of available crypto payment methods, thereby improving user experience while ensuring a pool's healthy liquidity. Through the disclosed inventive SwapBot 99 and UIUX 82a, access to buy or sell enterprise token 73 through multi-crypto DeFi pool 74a on several networks is easily facilitated through interface 95a shown graphically in FIG. 19 and by flow chart in FIGS. 20A and 20B.

As shown in step 1 of FIG. 20A, the SwapBot application 95a is opened on UIUX 82a hosted on a smartphone, desktop computer, or notebook. In step 2, the user selects Connects Wallet 95b to link their private (generally non-custodial) wallet 31 to SwapBot application 95a. In the example shown, the user selects their hypersecure CyberWallet. To process a transaction, the wallet needs to include an adequate amount of cryptocurrency to pay for transactional gas fees of the specific network, for example ETH on the Ethereum network, BNB on the Binance smartchain and so on.

In step 3, the user selects the blockchain network 95c from a menu of available network options 83z downloaded from the protocol library in accordance with the LaunchBot's generation of the DeFi pool. If a specific currency is available at TGE, the crypto cannot be added later. In an alternative embodiment, the smart contract includes provisions for supporting all major currencies but UIUX 82a prevents access (making it possible to enable later). In the example shown Ethereum is selected as the network for the trade.

In step 4, the user selects the form of crypto payment 95d from a list of options 92b. In the example shown, since the Ethereum blockchain was chosen as the transaction's network, the ERC-20 version of USDT is selected for payment. If however the Binance network had been selected the USDT made available would be made in accordance with the BEP-20 standard, not ERC-20. Once the currency for payment 95d is selected, in step 5 the SwapBot reports the present currency balance 95e in the wallet. If in step 95q the crypto balance is sufficient the transaction may proceed. If not, a new currency must be selected in step 95d or the transaction cancelled altogether.

Continuing to step 6 in FIG. 20B, the user then enters their intended purchase amount 95f specified in crypto and in step 7 selects the token they wish to acquire by entering its token symbol name 95, in the example shown the fictious token PRYS. The icon for the token 73 will automatically appear visually confirming the selection. At the same time, the number of calculated tokens you will receive at the market price (or at the TGE price if the tokens remain locked) are displayed. In step 8, if the user enters a purchase code 95h granting them a special price (e.g. PPT=$0.01, $0.025, $0.035) then special price is selected by conditional branch 95r and the newly calculated amount of tokens to be purchased 95i is displayed in step 9. Once the trader confirms the calculated amount is correct, in step 10 pressing the purchase button 95j executes the trade.

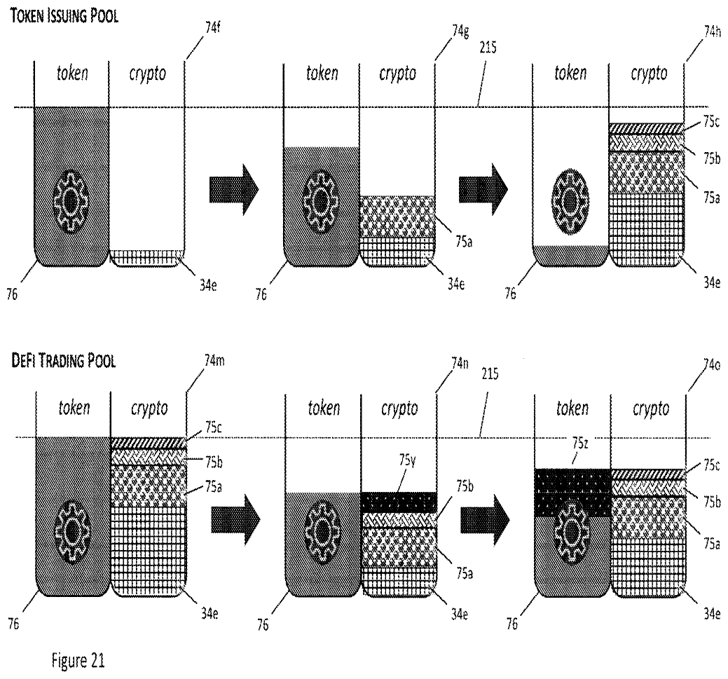

In this manner UIUX 82a combined with SwapBot 99 is able to support token distribution for both issuing pools, i.e. when an enterprise is launching a new token, and trading pools supporting DeFi trading. The primary differences between these two cases is one of token locking and the role of AMM DeFi 82c. The difference is illustrated in FIG. 21 contrasting purchases through SwapBot from a token launch against normal DeFi pool trading. In token issuing pool 74f enterprise tokens may be bought but not sold in the pool. As such, the pool commences selling with a fully collateralized offering of enterprise tokens 76 equal to the asset starting value 215 and with essentially no crypto 34e (shown slightly above zero for illustrations sake). At a later date pool 74g shows the aggregate value of enterprise tokens 76 has dropped and been replaced by an increase in crypto comprising WETH 34e and BUSD 75a. Assuming for the sake of simplicity there is no change in the market price of these crypto assets during launch the sum of the aggregate values of enterprise tokens 76 plus that of crypto 34e and 75a should still equal the calculated starting value 215 of the offering.

In reality the enterprise tokens are allocated into different tranches so that the token value is increasing as the offering proceeds. This effect is not included as it does not aid in explain the operation of the SwapBot. Later in pool 74h the inventory of enterprise tokens available for sale has dwindled in supply and value to 75 while the aggregate cash value collected by the enterprise through the offering now comprises the sum of asset values 34e plus 75a, 75b, and 75c, having a value approaching the original projected value 215.

In essence, in an issuing pool the SwapBot sells the newly issued enterprise token for crypto (cash equivalent) and does not replenish the token supply. Moreover, the major change in value assumed by this model is the change in the number of tokens and crypto in the pool and not market price fluctuations. After the offering is complete, the enterprise is free to receive the collected crypto to fund operations and development in accordance with stated use of proceeds.

By contrast, the use of the SwapBot in DeFi pool trading is completely different. As shown in this example pool 74m is funded by a liquidity provider to contain a set value of enterprise tokens 76 and an equal amount of value of crypto divided among various digital assets including WETH 34e, USDT 75a, BUSD, 75b, USDT 75c and Dai 75d. In such a case, both tokens and crypto each start with an aggregate asset value 215, so that the total pool value is the sum of the enterprise value plus an equal value of crypto, or double the value 215 of the issuing pool.

During trading depicted by pool 75n, the sale of enterprise tokens to the pool reduces the aggregate amount of crypto and increases the available amount of enterprise tokens 76 creating an imbalance between the two columns in the amount 75y. To rebalance the pool, investors acting as liquidity providers must rebalance the pool by either injecting capital into the pool in the amount of 75y in crypto, by selling some of the enterprise tokens in the market (i.e. outside the pool) and returning the net proceeds into the pool, or some combination thereof to ensure the pool remains balanced. While in pool 74n the crypto assets are lower than the tokens by an amount 75y, by contrast in pool 740 the converse is true where there is a shortage in enterprise tokens having an aggregate value 75z less than the crypto reserves. In such an instance investors must procure new enterprise tokens from the market and inject it into the pool using their own cash or by using a portion of the excess tokens to balance the pool.

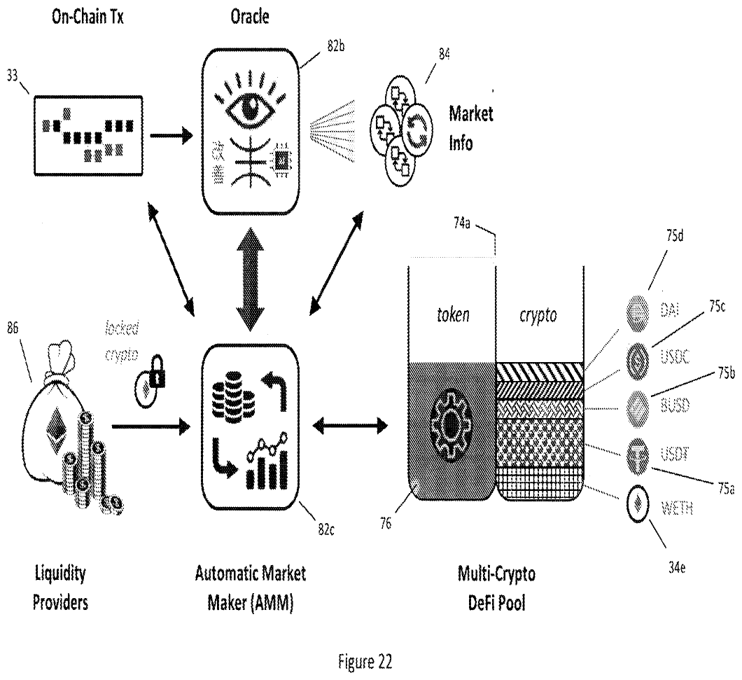

In either case, to maintain liquidity for both buyers and sellers, the pool must be rebalanced till the asset values are equal irrespective as to whether the net value of the assets is greater than or less than the starting value 215. This is the job of the automatic market maker AMM 82c shown in FIG. 22. In such cases liquidity providers 86 may input or remove value from multi-crypto pool 74a or to buy or sell the pool's assets to maintain balance between the cumulative crypto value of 34e, 75a, 75b, 75c, and 75d, and the enterprise token 76.

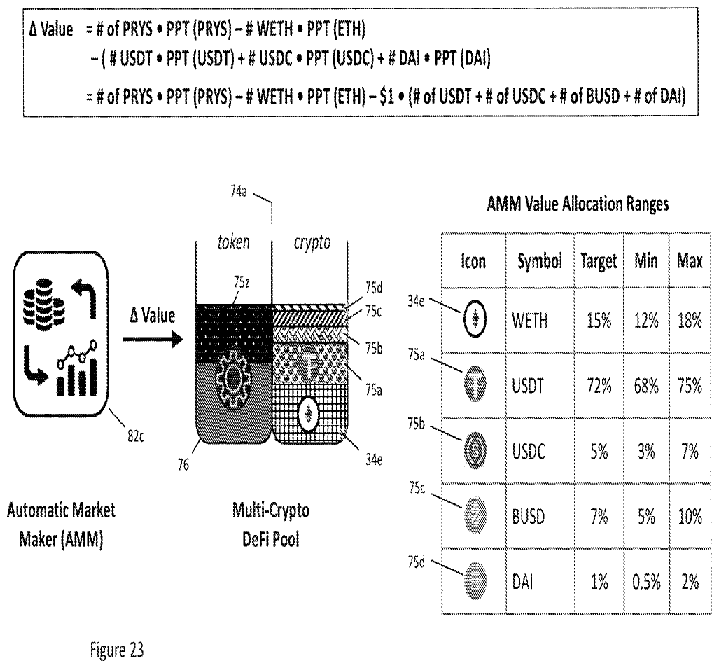

Each time a rebalancing occurs the DeFi Oracle 82b must ascertain the current market value of the pool's constituent assets base on current market information 84 and on-chain recorded transactions 33. The imbalance in value is sum of the number of tokens time its current price less the aggregate sum of all the crypto each valued at its market price as illustrated in FIG. 23. Unlike any other DeFi pool, AMM 82c is designed to balance the pool not only between the token's value 76 and the aggregated value of its WETH, USDT, BUSD, USDC, and Dai crypto assets, but also to maintain certain ratios among its crypto based on market liquidity and recent trading volumes. In the table shown, the inventory of each crypto asset has a target range comprising a minimum, a maximum and a target. Whenever the relative quantities of theses tokens fall outside the specified range, the AMM automatically adjusts them irrespective of whether the value ratio between the aggregate crypto value and the token are still within guidelines.

For example among the stablecoins, the volume and liquidity of USDT is by far greater than its peers. In contrast, Dai is a relatively small player in the stablecoin market. As shown in the table of Value Allocation Ranges, the AMM targets a USDT balance of 68% of the pools value with a slippage of approximately ±3.5%. The total amount of WETH is limited to 15%±3% to minimize market volatility risk. The disclosed invention represents the first multi-crypto pool and AMM.

The Need for Locked Tokens: Important considerations in the tokenomics of a new token launch are the total token offering (fully diluted) and the circulating supply of tokens. To prevent rampant selling by insiders (rug pulls) or panic selling and to encourage holding a newly issued token for long term gains, it is important to limit the supply of unlocked tokens available for selling at or soon after the public release of a token, i.e. at its TGE (token generation event).

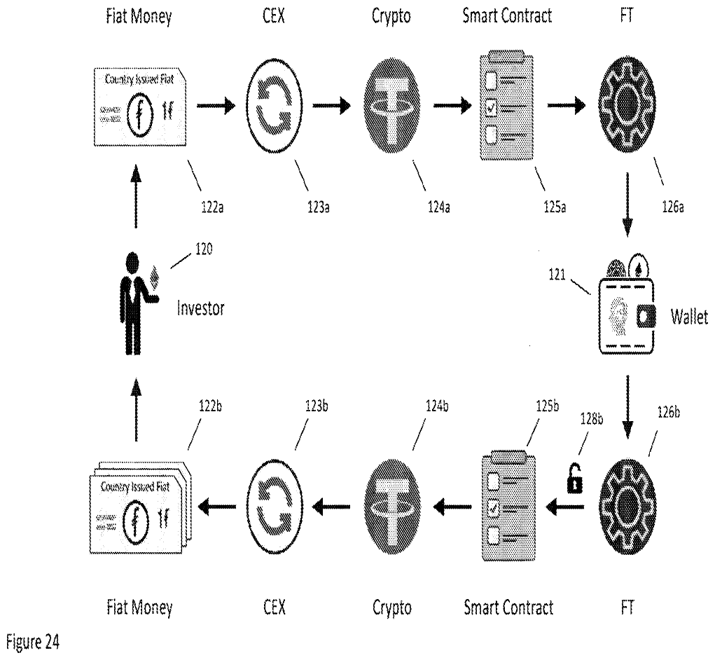

The problem of buy-sells is illustrated in the flow chart of FIG. 24 where an investor buying an enterprise token at a presale discount is able to unload the asset at a higher price as soon its public trading commences. The token issuer has no idea who is responsible for selling and how deep the selling pressure goes, especially when panic selling ensues. For example, investor converts fiat money 122a into crypto 124a (such as USDT) in centralized exchange CEX 123a, then purchases the new fungible token FT 126a during its presale through smart contract 125a. If the enterprise distributes the presale tokens to the investor they deposit the assets, token 126a in non-custodial wallet 121 and possibly subdivide the assets further into a myriad of smaller wallets (too numerous to track).

As soon as the token becomes available for public trading, the investor transfers unlocked token 126b to smart contract 125b, swapping it back into crypto 124b and then selling it in CEX exchange 123b for fiat money 122b and a quick profit. If the selling occurs when the trading volume of the token is low, even modest levels of selling can crash the selling price and irrevocably harm the perceived value of the token discouraging future investments.

Because the tokens are fungible, all issued tokens are identical, interchangeable and indistinguishable. As such it is impossible for some of the tokens issued to be locked while those used in the TGE public listing are unlocked and tradable. Either all the tokens are locked or al are unlocked. One solution to prevent early selling of presale tokens is simply not to distribute them, but simply to hold them in a dedicated enterprise wallet until a mutually acceptable date. While this solution appears trivial it creates a number of serious problems.

In particular, token investors generally are not the of people who trust in centralized authority—that's one reason they became DeFi traders, for its decentralization. Unremarkably they expect to receive proof-of-purchase at the time they procure their tokens. Having the issuer hold their tokens in a private wallet (for which they have no key) means they must trust the issuer will distribute the tokens at a later date (possibly months or years later) and that the issuer is responsible to manually execute the distribution process. Such a procedure is the antithesis of DeFi as it is neither autonomous nor permissionless. Manual processes are also not trustworthy but fraught with the potential for error or usurpation either through incompetence or malfeasance.

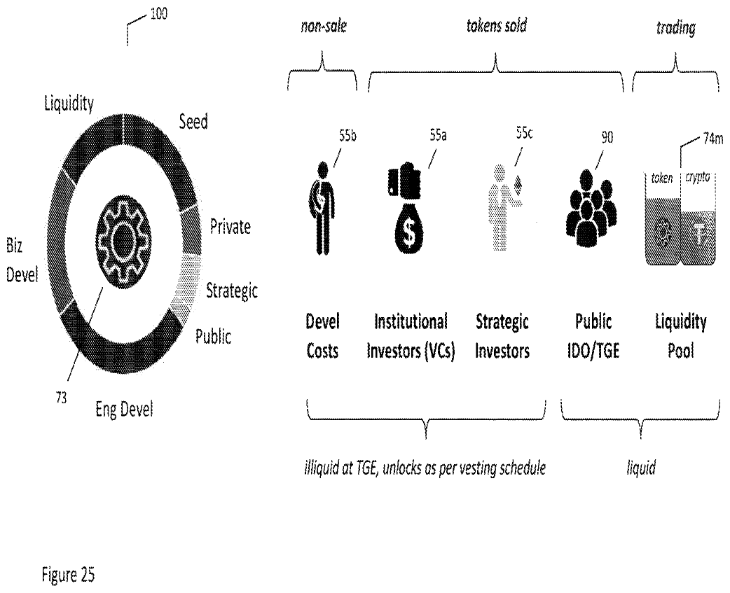

Another problem with manual distribution is its complexity and high cost. Every offering includes a combination of different tranches having their own vesting schedules. For example, FIG. 25 illustrates the wide variety of token recipients in a common tokenomic model 100 including institutional investors (VCs) 55a, strategic investors 55c, and private tranche investors—all of which expect purchased tokens to be offered in a locked state and vested over time. At TGE an additional category of locked tokens are reserved for engineering and business development 55b to defray project expenses, and are therefore are made available for free, albeit typically using a longer vesting schedule. Other tokens are necessarily released in an unlocked state from inception including the relatively small portion allocated for IDOs (initial DEX offerings) and for a public listing 90 at the token generation event (TGE). Additional unlocked tokens are distributed to one or more DeFi liquidity pools 74m to provide a means for market making following the TGE.

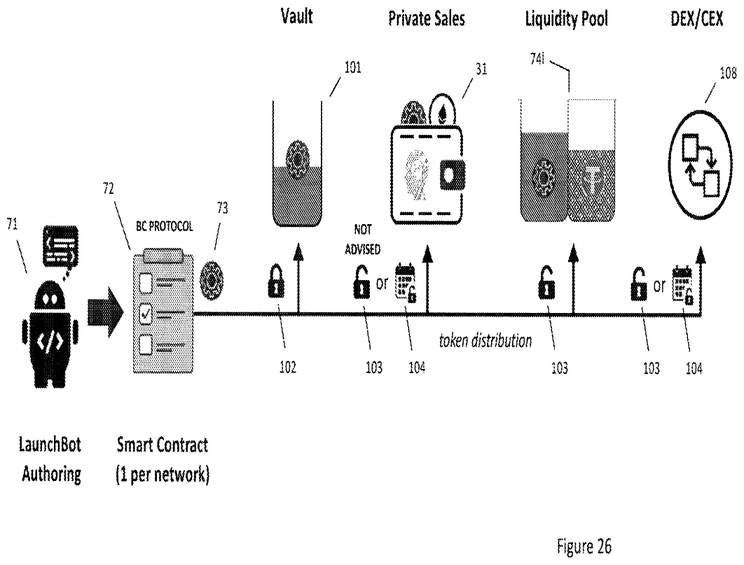

In order to provide confidence that token 73 distribution will occur as agreed, one approach is to execute the distribution through smart contracts 72, one per network, generated by the aforementioned LaunchBot 71 authoring system and certified by a third-party code validator (such as Certik) as compliant with a smart contract 72 defined vesting and distribution schedule using bug-free executable code. The complexity of multiple tranche multiple network token distribution is exemplified by the flow chart of FIG. 26 where tokens issued for private sales 31 are vested 104, sales to DEXs and CEXs 108 may be unlocked 103 or vested 104, and tokens for pool liquidity 741 are necessarily unlocked 103. Tokens in vault 101 may be locked 102 (to be manually unlocked later) or alternatively may be unlocked as per a vesting schedule 104. The problem with this approach is that tokens once distributed cannot be comingled with others intended to remain locked during vesting.

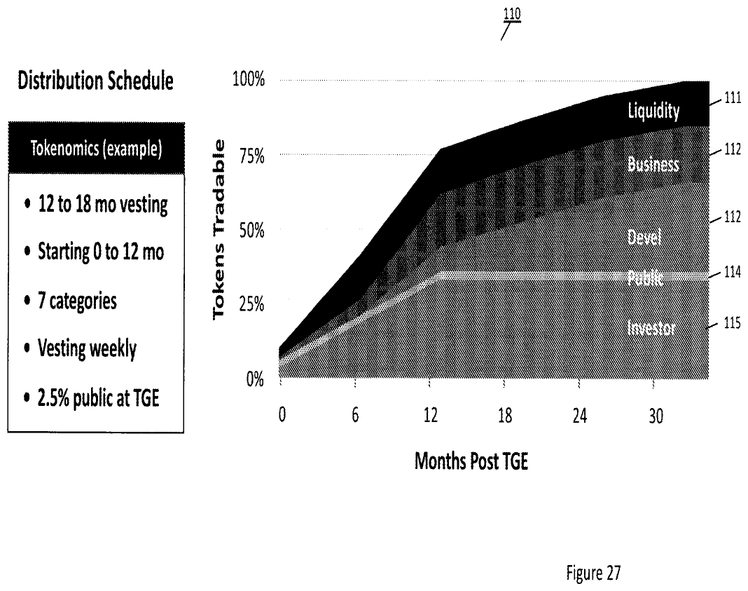

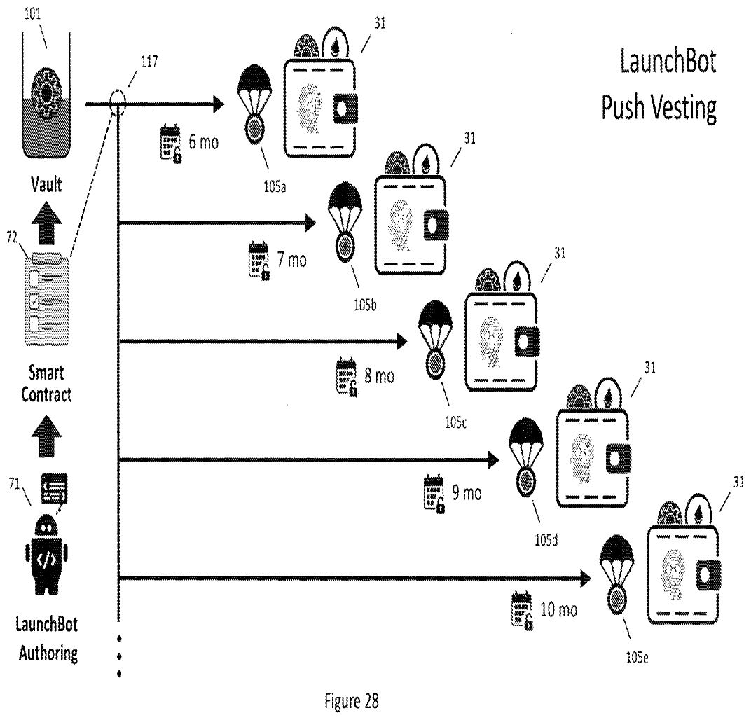

One exemplary vesting schedule comprising seven categories of unlocking schedules from 12 to 18 months with 0 to 12 month cliff vesting is represented graphically in FIG. 27 as divided including allocations for liquidity 111, business 112, development 112, public offering 114 and investors 115. One LaunchBot 71 implemented smart contract 72 distribution plan involves time vesting and distribution from token vault 101 using automated “push vesting”. As depicted in FIG. 28, LaunchBot specified distribution using push vesting means when a token becomes vested it is “pushed 117”, i.e. unlocked and airdropped to a specified address for recipient wallet 31 on particular dates. For example the first airdrop 105a occurs only after 6 months. Thereafter as shown, airdrops 105b, 105c, 105d, and 105e occur monthly on the 7^{th}, 8^{th}, 9^{th} and 10^{th} months respectively. Push vesting continues until all tokens are distributed.

While push vesting overcomes the issues of trust and vulnerability to hacking, the large number of airdrops, numbering in the thousands as executed over several years duration, is extremely expensive. Despite the high degree of automation, other problems may occur using push distribution. Since blockchain transfers are irrevocable, any change to a recipient's wallet address could result in the token being sent to a dead or locked wallet and lost forever. They is no means by which tokens once pushed to investor wallets can be clawed back. Moreover, for a variety of reasons such as tax implications investors may not wish to receive their tokens immediately upon vesting.

kTx Collateralized Transactional Tokens: A uniquely innovative technology for token distribution management disclosed herein is the collateralized transaction token having the acronym kTx (where k symbolizes the word collateralized and Tx is the abbreviation for transaction). In this method of token distribution investors do not receive tradable enterprise tokens for their investment but instead receive kTx tokens as proxies for the tokens they purchased. Like a redemption coupon, the kTx tokens can be exchanged for enterprise tokens at any time after the specific class of enterprise tokens becomes vested. Because fungible tokens are identical, indistinguishable, and interchangeable, there is no need to link the vesting of ant particular enterprise token a specific owner or wallet. Whenever a category of tokens becomes vested, every investor holding kTx tokens can redeem any amount up to their total vested amount at any time they wish. There is no need to push or transfer any enterprise tokens to investors. Instead they come claim their vested tokens whenever they so desire using the kTx token as proof of ownership and as a redemption coupon. In this way, the burden of token airdrops upon vesting and the corresponding risks of a wallet address errors are completely eliminated.

In the manner prescribed, the collateralized kTx token acts a ‘proxy token’ representing the real asset held in reserve locked in the issuing vault. The issuing vault is not a separate wallet or physical entity but a construct comprising the unissued portion of tradable enterprise tokens locked within the smart contract from inception, i.e. at TGE.

Although any conversion ratio is possible, in general one kTx is issued for every generated enterprise token, meaning the kTx-to-enterprise token redemption ratio is 1:1. Because the kTx tokens distributed to investors at the time of their investing mirror the number of unclaimed enterprise tokens, the enterprise tokens act as “collateral” for the kTx tokens. Since the kTx tokens are never listed on any public exchange their intrinsic value reflects the value of their underlying asset, the enterprise token. Because they carry their collateral's implicit value the kTx tokens can be used as proof-of-ownership and may be utilized in private transactions, allowing the kTx token to be hypothecated in a variety of transactions (such as staking) even though its underlying collateral is still unvested and locked. The nominative collateralized transaction token is therefore descriptive—the token may be used in transactions in accordance with the net present value of its underlying collateral.

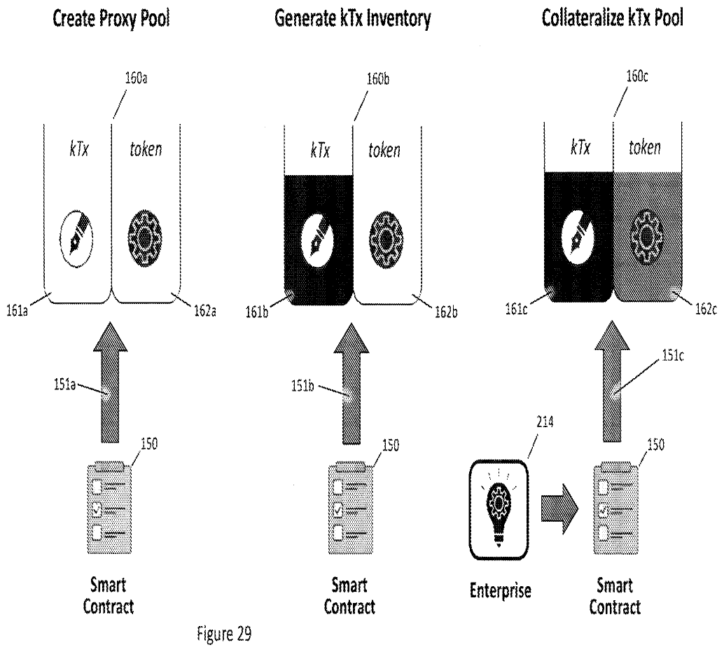

Although it is possible to create a kTx token after TGE (as a secondary trading market or derivative) in practice the kTx token is cogenerated with its collateral enterprise token within the same smart contract. Although inception of the enterprise token and its kTx proxy occur simultaneously within the issuing smart contract at TGE, it is easier to visualize the process stepwise as depicted in FIG. 29. As shown, LaunchBot generated smart contract 150 first creates 151a proxy pool 160a as registers for tracking the total number of kTx tokens 161a and the total supply of enterprise tokens 162a. At the moment of birth the total assets contained in the pool are zero. Instantaneously thereafter in step 151b smart contract generates a fixed supply of kTx token 161b. At this moment, the generated kTx tokens in proxy pool 160b hold no value as they are not collateralized by any asset of real value.

In step 151c however, enterprise 214, a business or DAO with purpose or value, approves and instructs smart contract 150 to generate a fixed number of enterprise tokens 162c in the amount equal to the supply of kTx tokens, i.e. on a one-for-one basis. The total value of proxy pool 160c is not double the value of the enterprise tokens it contains, as only one of the tokens can be issued and circulating at a time. Specifically, for every fixed number of kTx tokens issued, the same number of enterprise tokens must remain in pool 160c as collateral. If the kTx tokens are redeemed for enterprise tokens, the kTx are surrendered to the pool and thereby removed from circulation. In one embodiment, kTx tokens once redeemed are burned, i.e. irrevocably destroyed, preventing their redistribution later to avoid risk of reuse and any fraud therefrom. Because the proxy pool contains only kTx and enterprise tokens, the proxy pool is incapable of selling either asset for value. Instead it relies on a companion pool, the swap pool, for enabling trade.

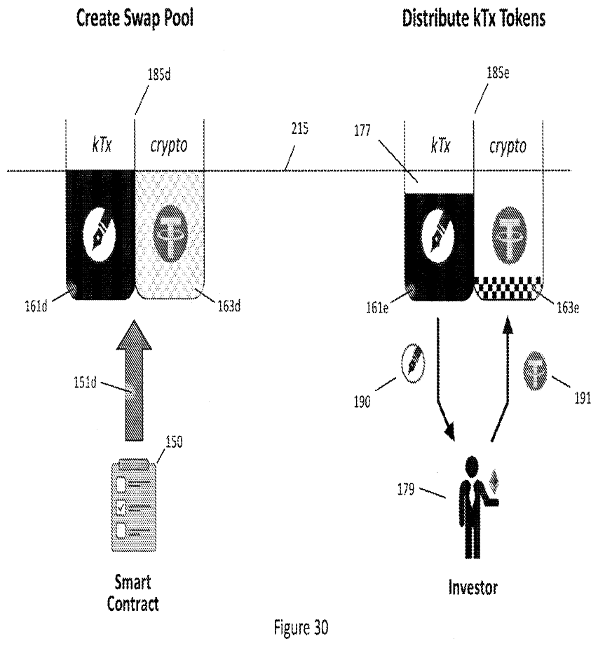

This next step in deploying the kTx transactional tokens is the creation of a swap pool as shown in FIG. 30. In step 151d, the smart contract creates a new register 163d for transacting and holding fungible tradable crypto (such as WETH, USDT, USDC, BUSD or Dai). The second half of swap pool 185d contains the kTx token supply 161d, the same supply as kTx 161c recorded in swap pool 160c.

In other words, the kTx supply is registered in two pool pools—together with the enterprise token in proxy pool 160c and together with fungible tradable crypto in swap pool 185d. Thereafter, investor 179 transfers crypto 191 into the swap pool and receives kTx token 190 at the same price as its collateral, the enterprise token to be issued at TGE. After receiving a crypto transfer into swap pool 185e, the asset value of crypto 163e grows commensurately while the kTx token supply 161e drops by an identical amount 177. The total aggregate value of the underlying collateral for kTx tokens 161e plus the market value of the crypto 163e received at the moment of the trade equal the sum total 215, the same value just prior to the swap.

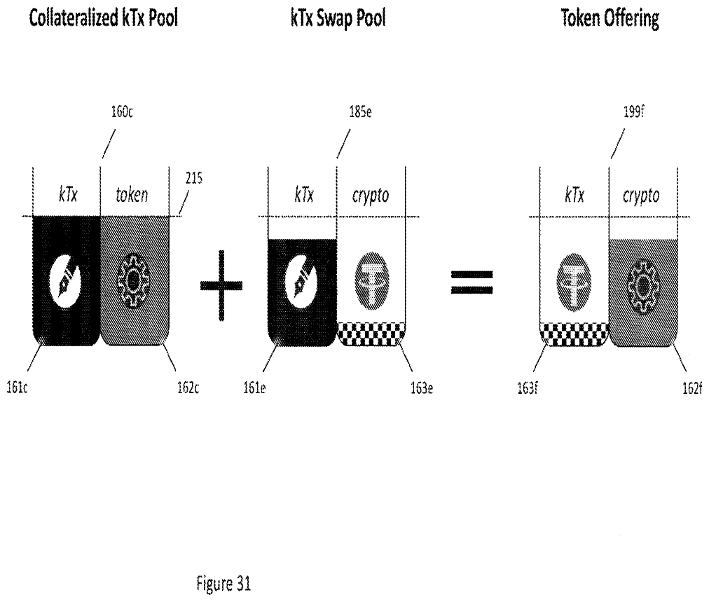

As illustrated in FIG. 31, because the kTx token supply 161e is shared by both proxy pool 160c and swap pool 185e, the combination of the two operate as a virtual token offering pool 199f containing crypto 163f and enterprise tokens 162f and with aggregate value 215. So by selling enterprise tokens to investors but delivering kTx tokens instead, the purchaser feels the confidence in knowing they hold a proxy token which represents their underlying collateral and which can be redeemed at a subsequent date for the fungible enterprise token once it is listed and unlocked.

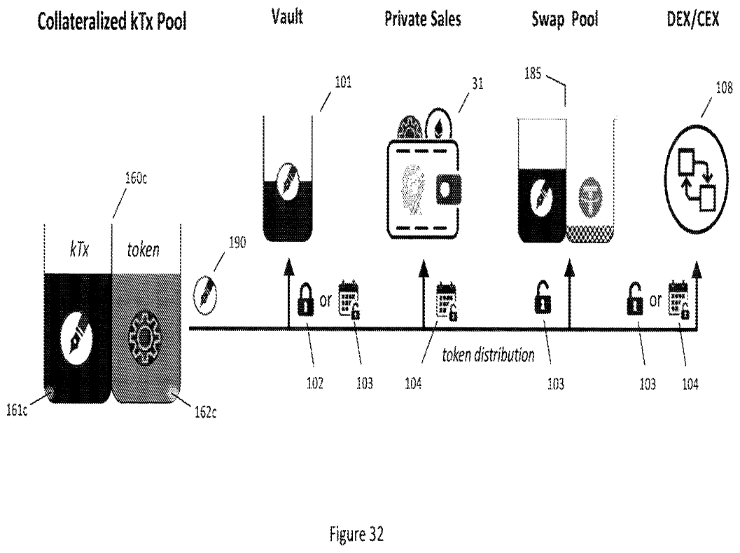

In so doing, early selling of locked enterprise tokens is completely eliminated while still facilitating convenient distribution. Rather than unlocking and distributing enterprise tokens, in FIG. 32 token offering pool 160c issues proxy tokens 190 while retaining its locked token supply 162c. As shown, kTx trading occurs via swap pool 185, through IDOs with exchanges 108, to private wallets 31 or retained in vault 101 for later distribution such as a secondary (follow on) offering. So although investors are purchasing the enterprise tokens, they receive kTx tokens in their stead. Although the kTx tokens themselves are issued unlocked, because they remain unlisted indefinitely, they cannot be sold or traded on any public exchange. There only value is in their redemption for their enterprise token collateral. The vesting 104 and unlocking 103 of locked tokens 102 does not refer to the kTx token but in its ability to be redeemed for its enterprise token collateral.

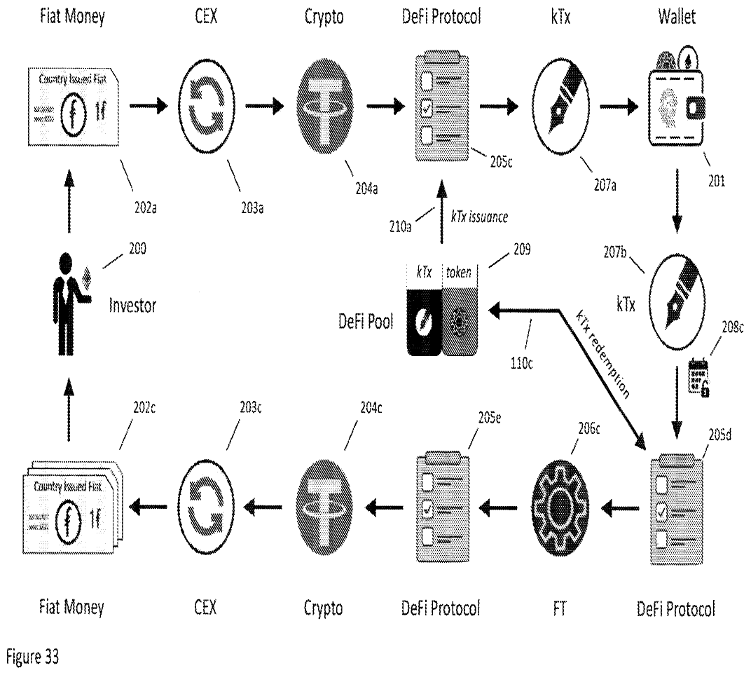

Compared to the problematic unauthorized early selling issue depicted previously in FIG. 24, using kTx collateralized tokens early selling quandary is completely eliminated as shown in FIG. 33. As in the prior example, investor 200 converts fiat money 202a into crypto 204a in exchange 203a and then invests in a token presale executed by smart contract 205c. But rather than receiving enterprise tokens, proxy pool 209 releases 210a only kTx tokens 207a to the investor. Through SwapBot 71 the kTx tokens are delivered in unlocked form to the investors wallet 201. Although the kTx tokens are unlocked, the enterprise token collateral remain locked pursuant to vesting 208c.

Once a fixed portion of enterprise tokens become vested 208c, an equal number of kTx tokens can be redeemed 110c from proxy pool 209 via smart contract 205d, delivering to the investor fungible tradable enterprise tokens 206c which may be held or alternatively sold.

If the investor wished to sell their unlocked enterprise tokens 206c they can execute such a trade in an exchange of through smart contract 205e receiving crypto 203c at market rates and subsequently (if desired) converting the crypto into fiat money 202c in exchange 203c. In this manner only vested and unlocked enterprise tokens can be redeemed for an equal number of kTx tokens upon vesting. As such early selling is prevented autonomously without any intervention by the issuing enterprise.

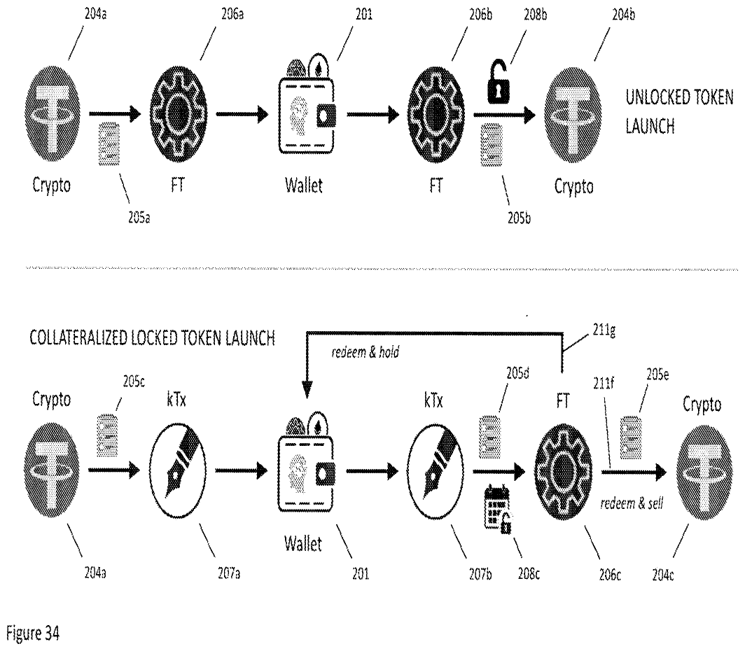

FIG. 34 contrasts the collateralized token launch process to an unlocked token launch where rather than crypto 204a being converted into a fungible tradable token 206a by smart contract 205a, improved smart contract 205c made in accordance with this invention issues a kTx collateralized transaction token subsequently deposited into wallet 201. While in an unlocked 208b token distribution, fungible token 206b can immediately be sold 205b in exchange for crypto 204b, in the improved process the kTx token 207b can only be redeemed for a fungible enterprise token 206c when smart contract 205d determines vesting 208c has occurred. Once claimed, the fungible token 206c can be held 211g in wallet 201 or otherwise sold 211f for crypto 204c by smart contract 205e.

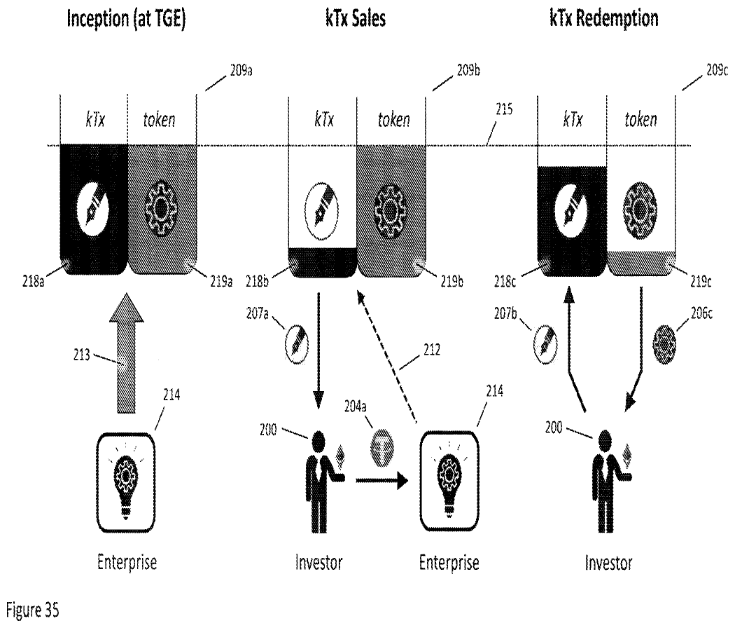

Changes over time in the token supply within the swap pool during trading are illustrated in FIG. 35 where at inception 213 enterprise 214 starts with an even value 215 of enterprise tokens 2919a and kTx tokens 218a. During kTx sales but prior to unlocking investors 200 purchase enterprise tokens from enterprise 214 with crypto 204a but receive kTx tokens 207a instead thereby diminishing the available supply of kTx tokens 218b in swap pool 209b but retaining the token collateral 219b. After vesting during redemption shown by pool 209c, the level of enterprise tokens 219c drop as tokens 206c are distributed to investors 200 redeeming their kTx tokens 207b causing the reclaimed kTx token supply 218c to rise until such time that all enterprise tokens have been issued. In one embodiment all kTx recovered by exchanged are burned and irrevocably destroyed to prevent the risk of theft and misuse. Although the dual column diagrams illustrate the relative levels of the kTx and enterprise tokens the graphic fails to accurately account for all the transactions because the cumulative crypto payments are not represented.

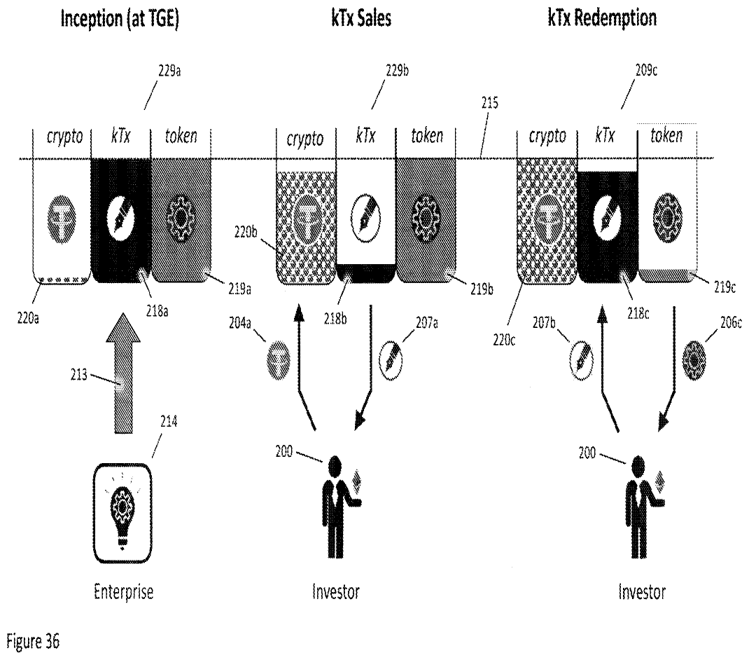

A superior representation of tokenomic transactions in an issuing pool is shown by the tri-column graphics shown in FIG. 36, describing the relative asset values at inception, during kTx sales, and during kTx redemption in pools 229a, 229b, and 229c respectively. Specifically at inception 213 enterprise 214 populates tri pool 229a with an equal amount or crypto 219a and kTx tokens 218a while the token value 220a is essentially zero. During kTx sales investors 200 supply crypto 204a and in return receive kTx tokens 207a and proxies for the enterprise token collateral for the pool. The process of selling kTx token selling causes the token value 220b to rise while the number of kTx tokens in the pool diminish 218b to a value near zero. During the kTx sales the total enterprise tokens 219b remains constant.

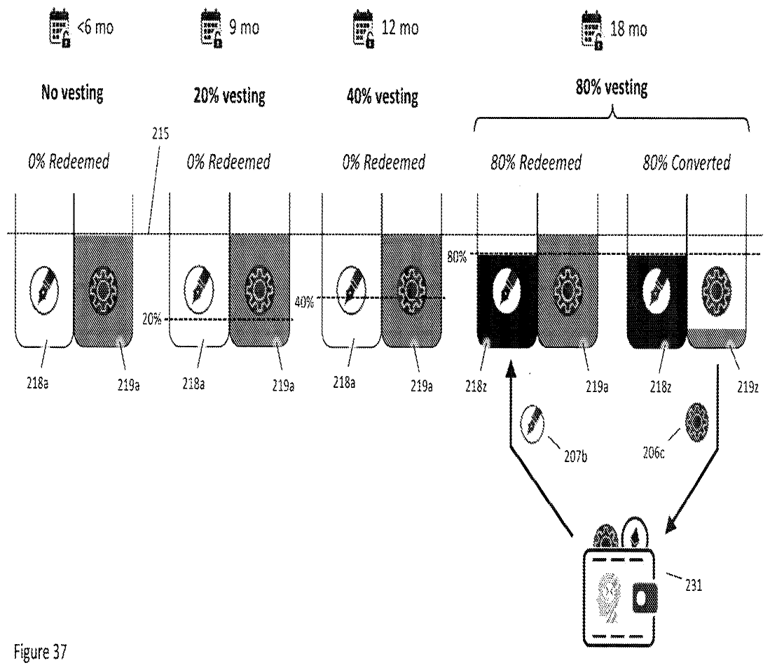

During kTx redemption shown by tri-column pool 209c investors redeem the kTx tokens 207b for enterprise tokens 206c causing the kTx level 218c to rise as the supply of available enterprise tokens 219c dwindles. During the redemption phase, the crypto asset level 220c remains constant (at least until the enterprise withdraws the funds received from the pool to fund operations and development in accordance with the offering's use-of-proceeds). Redemption of kTx tokens for enterprise tokens need not occur at the moment of vesting. For many reasons include income reporting and taxation, investor may choose not to claim their vested tokens. FIG. 37 illustrates the swap pool asset levels over a exemplary 18 month vesting period starting with value 215. As shown, at 6 mo, 9 mo and 12 mo the vested number of tokens rises from 0% to 20% to 40% respectively although no kTx tokens were redeemed, the enterprise token level 219a remains at 100% and the kTx level 218a remains at zero. Then at 18 months when the investor is 80% vested, wallet 231 redeems kTx tokens 27b in an amount of 80% shown by 218z, that is 100% of its vested unlocked enterprise tokens. In response to the redemption of 218z kTx tokens, the pool issues unlocked tradable enterprise tokens 206c is an amount dropping the level of remaining enterprise tokens 219z down to only 20% remaining.

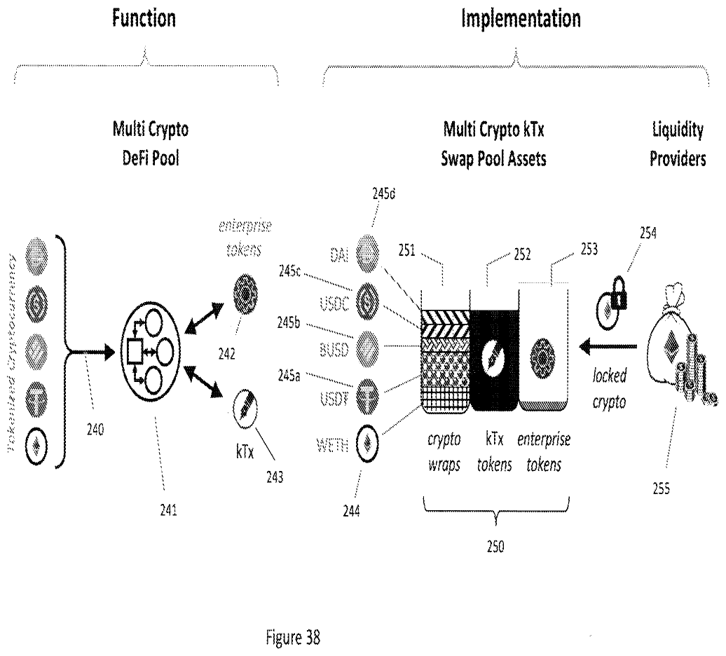

Although the aforementioned description of kTx based trading involved only a single denomination of crypto, the principle of a multi-crypto pool is equally applicable in multicurrency pools as shown in FIG. 38. As shown, liquidity providers 255 supply crypto assets 254 to tri pool 250 comprising enterprise tokens 253, kTx tokens 252 and multi-crypto pool 250 which may include any combination of WETH 244, USDT 245a, BUSD 245b, USDC 245c, and Dai 245d. Graphically is convenient to represent multi-crypto pool using icon 241 when interacting with crypto 240, kTx tokens 243, and enterprise tokens 242.

Token Swapping and/or Staking: Using the disclosed methods, the enterprise token once generated may be used to stake a DeFi pool in exchange for earned interest. The DeFi pool APY may be fixed or variable, and the term, daily, monthly, quarterly, or yearly. In this manner token holders are economically encouraged not to sell their tokens.

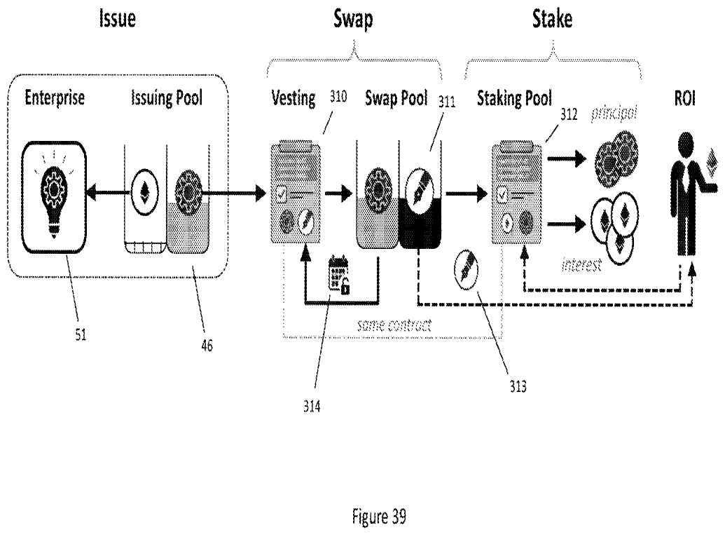

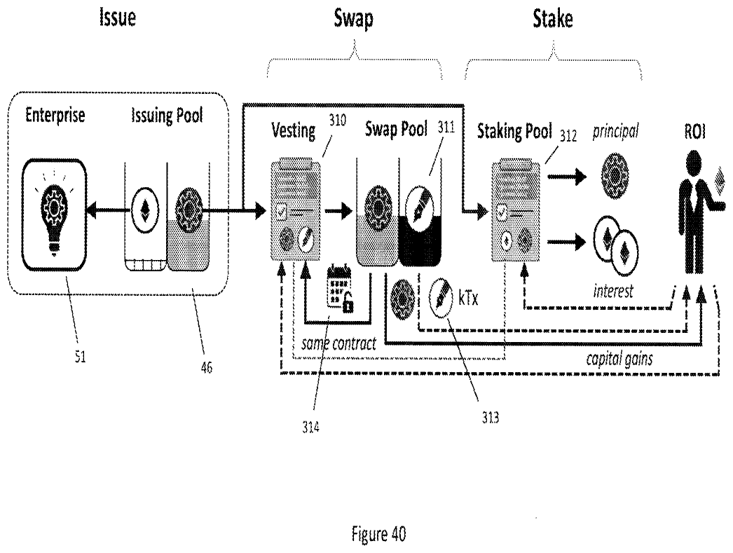

In particular, kTx holders may hypothecate their tokens for additional returns either by (i) staking them to earn interest, (ii) subdividing a portion for staking and another portion for swapping, aka kTx stake & swapping, or (iii) swapping their kTx tokens in a manner that automatically invests the enterprise token into the staking pool for some fixed duration. For example FIG. 39 illustrates a swap then stake feature where an investor's kTx tokens are deposited 313 to vesting contract 310 in advance of vesting. Upon vesting the kTx tokens are automatically redeemed from swap pool 311 for enterprise tokens and staked for an defined term in staking contract 312, thereby effectively locking the tokens up for a longer duration in exchange for a higher rate of return. FIG. 40 illustrates an alternative method where the kTx tokens 313 are used concurrently for staking 312 and for swapping 311 pursuant to a defined vesting schedule 312.

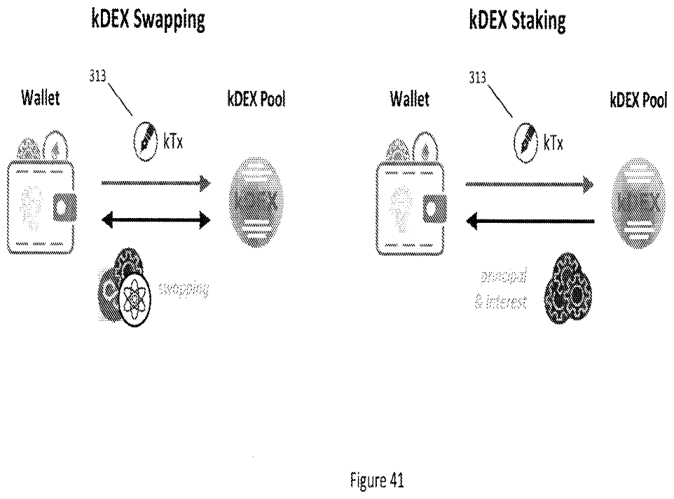

Alternatively FIG. 41 shows kTx tokens may be used in advanced of their collateral unlocking to for token swapping in a collateralized token decentralized exchange (KDEX) or alternatively for staking in interest bearing accounts. The value of kTx tokens in the KDEX may be reduced from its collateral's true market value. As the vesting date nears the market value of the kTx tokens in the KDEX will gradually approach the market value of the underlying enterprise tokens.

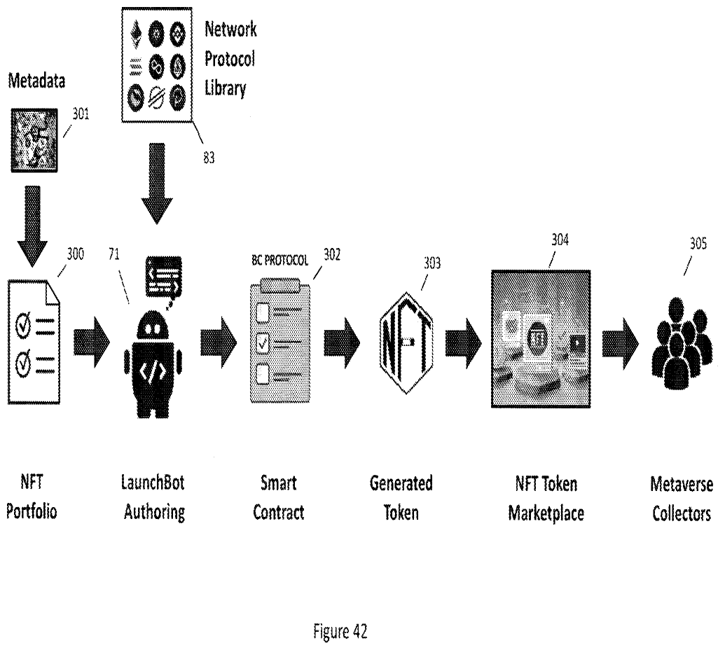

NFT Transactions: The same autonomous LaunchBot dApp is able to generate NFTs. As shown in FIG. 42, the input file 300 for generating a portfolio of NFTs includes metadata file 301. LaunchBot 71 combines the input and blockchain specific data from network protocol library 83 to generate smart contract 302 launching the new NFTs 303 on one or more networks. Unlike fungible tokens issued in a DeFi pool the generated NFTs are immediately available for trading with metaverse collector 305 in any number of NFT marketplaces irrespective of the blockchain on which the non-fungible tokens are first generated.

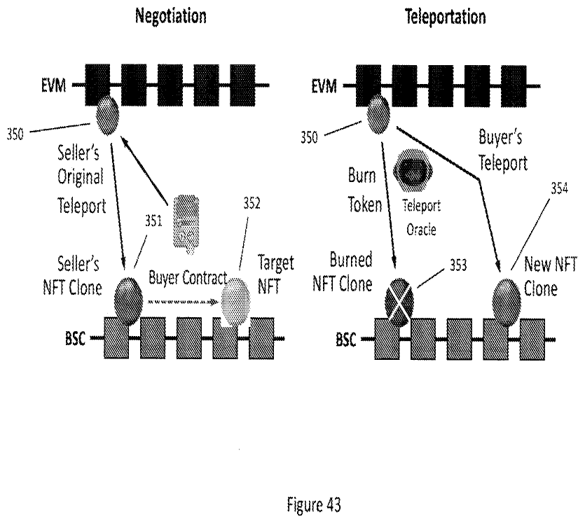

If a trader wishes to engage with collectors on a separate blockchain, the token ecosphere includes a NFT teleporter feature as shown in FIG. 43. In token teleportation, a token holder of NFT 350 on the EVM can offer teleported NFT clone to a buyer on BSC, where smart contract 351 identifies the target wallet and network. But rather than transferring a wrapped token as bridging procedures use, a new wrap is initiated from the original token 350 and teleported to the buyer as NFT clone 354. Meanwhile the prior token instance 351 is burned 353 destroying any duplicate risks. In this manner, all teleported tokens only contain a single wrap and never involve nested wraps with hidden gas expenses.

1. A method of distributing cryptographic tokens wherein:
a number of fungible tokens are generated by one or more smart contracts during a token generation event, wherein
a portion of the fungible tokens are made available for public sale and distribution by an issuer of the fungible tokens, and
a portion of the fungible tokens remain locked in accordance with a defined vesting schedule;
a number of transaction tokens equal to the number of fungible tokens are generated concurrently during the token generation event and wherein the transaction tokens are distributed to investors in exchange for payments received in the form of stablecoins or cryptocurrency wraps; and
the transaction tokens are redeemed for an equal quantity of fungible tokens that are vested and have been unlocked for trading.

2. The method of claim 1 wherein the generation of the fungible tokens and the generation and redemption of the transaction tokens are executed autonomously by one or more smart contracts and recorded on one or more blockchain networks.

3. The method of claim 2 wherein the one or more smart contracts are concurrently launched on more than one blockchain network.

4. The method of claim 1 wherein the transaction tokens, after being redeemed for the unlocked fungible tokens, are irrevocably destroyed.
